(19) United States
(12) Patent Application Publication
(10) Pub. No.: US 2010/0322582 A1
(43) Pub. Date: Dec. 23, 2010

(54) High Capacity Fiber Optic Connection Infrastructure Apparatus

(76) Inventors: Terry L. Cooke, Hickory, NC (US); David L. Dean, JR., Hickory, NC (US); Harley J. Staber, Coppell, TX (US); Kevin L. Strause, Keller, TX (US); Alan W. Ugolini, Hickory, NC (US)

Correspondence Address: CORNING INCORPORATED, INTELLECTUAL PROPERTY DEPARTMENT, SP-TI-3-1, CORNING, NY, 14831, US

(21) Appl. No.: 12/819,065

(22) Filed: Jun. 18, 2010

Related U.S. Application Data
(60) Provisional application No. 61/218,882, filed on Jun. 19, 2009.

(51) Int. Cl. G02B 6/00

(52) U.S. Cl. 385/135

(57) ABSTRACT

A fiber optic apparatus for use with components for managing data is disclosed. The fiber optic apparatus comprises fiber optic equipment configured to provide optical connectivity for the transmission of data over optical fiber between at least two components. The fiber optic equipment supports the transmission of at least about 7300 terabytes of data per forty-two (42) U shelf spaces. The at least 7300 terabytes of data is the data managing capacity of the at least two components. One of the at least two components may be a data storage facility, a server or a switch. The fiber optic equipment may be mounted in a fiber optic equipment rack in a data center which may be configured to occupy between about 3.20 and about 3.76 square feet of floor space of the data center.

### PRIORITY APPLICATION

The present application claims the benefit of U.S. Provisional Application Ser. No. 61/218,882 filed on Jun. 19, 2009, the entire contents of which are incorporated by reference herein.

### BACKGROUND

1. Field of the Disclosure

The technology of the disclosure relates to fiber optic apparatus for interconnecting components, including a fiber optic apparatus in a high capacity fiber optic connection infrastructure designed to provide optical connectivity between two or more components in a system based on the data capacity of the system.

2. Technical Background

The increased prevalence of computerized communication and applications, particularly for business purposes, has resulted in the proliferation of information in the form of digital data. What in the past was documented and recorded on paper, may now be recorded on some type of electronic medium for dissemination and/or storing. As a result, a need for a way to store and retrieve the data has developed. Data centers have been designed to respond to this need. In this manner, the data center provides a central location for a business to store the data that is important and necessary for the continued operation of the business. By storing its data in a data center, the business may be assured that the data is stored in a safe, environmentally conditioned and secure location. Additionally, systems may be incorporated in the data center to manage the storage and retrieval of the data to facilitate the on-going operational functioning of the business.

As the business operations continue, the demand for uses of digital data expands. This results in the need for increased data storage capacity in the data center, as well as, additional structures and applications for effectively and efficiently managing the receipt, storage and retrieval of data in the data center. Discrete components and hardware may be incorporated to provide the necessary functions for the effective and efficient management of a data center and the data therein. In particular, data centers may contain some type of data storage facility such as a storage area network. Therefore, in order to function in a coordinated manner, the components and hardware have to be able to communicate by transmitting and receiving data between each other. Such communication may be facilitated by interconnecting the components using a connection infrastructure. However, the equipment and components in a data center may occupy a relatively large amount of space, and in particular a relatively large amount of floor space. Thus, as the data capacity of the data center increases the amount of floor space that the equipment and components, including the connection infrastructure, occupy may also increase. This results in additional cost to the business.

### SUMMARY OF THE DETAILED DESCRIPTION

In one embodiment there is provided a fiber optic apparatus with components for managing data is disclosed. The fiber optic apparatus comprises a fiber optic equipment configured to provide optical connectivity for the transmission of data over optical fiber between at least two components. The fiber optic equipment supports the transmission of at least about 7300 terabytes of data per forty-two (42) U shelf spaces. The at least 7300 terabytes of data is the data managing capacity of the at least two components. One of the at least two components may be a data storage facility. One of the at least two components may be a server. One of the at least two components may be a switch.

A further embodiment includes a fiber optic apparatus with components for managing data is disclosed. The fiber optic apparatus comprises a fiber optic equipment rack configured to provide optical connectivity for the transmission of data between at least two components. The fiber optic equipment supports the transmission of at least about 14,400 terabytes of data per forty-two (42) U shelf spaces. The at least 7300 terabytes of data is the data managing capacity of the at least two components. One of the at least two components may be a data storage facility. One of the at least two components may be a server. One of the at least two components may be a switch.

A further embodiment includes a fiber optic apparatus comprising a fiber optic equipment rack configured to hold fiber optic equipment providing optical connectivity for the transmission of data between two or more of the components, wherein the fiber optic equipment rack is configured to support the transmission of data based on a data capacity of a data center. The data capacity of the data center may be one of at least 7300 terabytes of data and 14,400 terabytes of data per 42 U shelf spaces. The fiber optic equipment rack is configured to occupy between about 3.20 square feet and about 3.76 square feet of floor space.

A further embodiment includes a data center architecture having a data storage facility having a data storing capacity, an equipment distribution area and a main distribution area. The equipment distribution area comprises one or both of a server and a switch to process data of the data storage facility. The main distribution area comprises fiber optic equipment configured to support the transmission of data between at least two of the data storage facility, the server, and the switch based on the data storing capacity of the data storage facility.

Additional features and advantages will be set forth in the detailed description which follows, and in part will be readily apparent to those skilled in the art from that description or recognized by practicing the invention as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a front perspective view of an exemplary fiber optic equipment rack with an installed exemplary 1-U size chassis supporting high-density fiber optic modules to provide a given fiber optic connection density and bandwidth capability, according to one embodiment;

FIG. 2 is a rear perspective close-up view of the chassis of FIG. 1 with fiber optic modules installed in fiber optic equipment trays installed in the fiber optic equipment;

FIG. 3 is a front perspective view of one fiber optic equipment tray with installed fiber optic modules configured to be installed in the chassis of FIG. 1;

FIG. 4 is a close-up view of the fiber optic equipment tray of FIG. 3 without fiber optic modules installed;

FIG. 5 is a close-up view of the fiber optic equipment tray of FIG. 3 with fiber optic modules installed;

FIG. 6 is a front perspective view of the fiber optic equipment tray of FIG. 3 without fiber optic modules installed;

FIG. 7 is a front perspective view of fiber optic equipment trays supporting fiber optic modules with one fiber optic equipment tray extended out from the chassis of FIG. 1;

FIG. 8 is a left perspective view of an exemplary tray guide disposed in the chassis of FIG. 1 configured to receive fiber optic equipment trays of FIG. 6 capable of supporting one or more fiber optic modules;

FIGS. 9A and 9B are perspective and top views, respectively, of an exemplary tray rail disposed on each side of the fiber optic equipment tray of FIG. 3 and configured to be received in the chassis of FIG. 1 by the tray guide of FIG. 8;

FIGS. 10A and 10B are front right and left perspective views, respectively, of an exemplary fiber optic module that can be disposed in the fiber optic equipment trays of FIG. 3;

FIG. 11 is a perspective, exploded view of the fiber optic module in FIGS. 10A and 10B;

FIG. 12 is a perspective top view of the fiber optic module of FIG. 11 with the cover removed and showing a fiber optic harness installed therein;

FIG. 13 is a front view of the fiber optic module of FIG. 11 without fiber optic components installed;

FIG. 14 is a front right perspective view of another alternate fiber optic module that supports twelve (12) fiber MPO fiber optic components and which can be installed in the fiber optic equipment tray of FIG. 3;

FIG. 15 is front right perspective view of another alternate fiber optic module that supports twenty-four (24) fiber MPO fiber optic components and which can be installed in the fiber optic equipment tray of FIG. 3;

FIG. 16 is a front perspective view of an alternate fiber optic module being installed in the fiber optic equipment tray of FIG. 3;

FIG. 17 is front right perspective view of the fiber optic module of FIG. 16;

FIG. 18 is a front view of the fiber optic module of FIGS. 16 and 17;

FIG. 19 is a front perspective view of another alternate fiber optic module being installed in the fiber optic equipment tray of FIG. 3;

FIG. 20 is front right perspective view of the fiber optic module of FIG. 19;

FIG. 21 is a front view of the fiber optic module of FIGS. 19 and 20;

FIG. 22 is a front perspective view of another alternate fiber optic module being installed in an alternate fiber optic equipment tray that can be installed in the chassis of FIG. 1;

FIGS. 23 is front right perspective view of the fiber optic module of FIG. 22;

FIG. 24 is a front view of the fiber optic module of FIGS. 22 and 23; and

FIG. 25 is a front perspective view of alternate exemplary 4-U size fiber optic chassis that can support the fiber optic equipment trays and fiber optic modules according to the fiber optic equipment tray and fiber optic modules disclosed.

FIG. 26 illustrates a schematic diagram of a data center architecture having components including a server, a switch, a storage and a fiber optic interconnection structure, according to an exemplary embodiment;

FIG. 27 is a front, perspective view of a fiber optic equipment rack with fiber optic equipment disposed therein, according to an exemplary embodiment; and

FIG. 28 is a front elevation view of the arrangement of the equipment racks housing the components and fiber optic equipment of the data center of FIG. 26.

### DETAILED DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

Embodiments disclosed in the detailed description include high-density fiber optic modules and fiber optic module housings and related equipment. In certain embodiments, the width and/or height of the front opening of fiber optic modules and/or fiber optic module housings can be provided according to a designed relationship to the width and/or height, respectively, of a front side of the main body of the fiber optic modules and fiber optic module housings to support fiber optic components or connections. In this manner, fiber optic components can be installed in a given percentage or area of the front side of the fiber optic module to provide a high density of fiber optic connections for a given fiber optic component type(s). In another embodiment, the front openings of the fiber optic modules and/or fiber optic module housings can be provided to support a designed connection density of fiber optic components or connections for a given width and/or height of the front opening of the fiber optic module and/or fiber optic module housing. Embodiments disclosed in the detailed description also include high connection density and bandwidth fiber optic apparatuses and related equipment. In certain embodiments, fiber optic apparatuses are provided and comprise a chassis defining one or more U space fiber optic equipment units, wherein at least one of the one or more U space fiber optic equipment units is configured to support a given fiber optic connection density or bandwidth in a 1-U space, and for a given fiber optic component type(s).

Additionally, in certain embodiments a fiber optic apparatus with components for managing data is disclosed. The fiber optic apparatus comprises a fiber optic equipment rack defining at least 42 U space fiber optic equipment units and configured to hold fiber optic equipment providing optical connectivity for the transmission of data between two or more of the components. The fiber optic equipment rack is configured to support the transmission of data based on a components data managing capacity of at least about 7300 terabytes of data. A further embodiment includes a fiber optic apparatus with components for managing data is disclosed. The fiber optic apparatus comprises a fiber optic equipment rack defining at least 42 U space fiber optic equipment units and configured to hold fiber optic equipment providing optical connectivity for the transmission of data between two or more of the components. The fiber optic equipment rack is configured to support the transmission of data based on a components data managing capacity between at least about 7300 terabytes of data and about 14,400 terabytes of data. A further embodiment includes a fiber optic apparatus comprising a fiber optic equipment rack configured to hold fiber optic equipment providing optical connectivity for the transmission of data between two or more of the components, wherein the fiber optic equipment rack is configured to occupy between about 3.20 square feet and about 3.76 square feet of floor space. The fiber optic equipment rack is configured to support the transmission of data based on the system having a capacity to manage at least 7300 terabytes of data.

Further, as used herein, it is intended that the terms “fiber optic cables” and/or “optical fibers” include all types of single mode and multi-mode light waveguides, including one or more bare optical fibers, loose-tube optical fibers, tight-buffered optical fibers, ribbonized optical fibers, bend-insensitive optical fibers, or any other expedient of a medium for transmitting light signals.

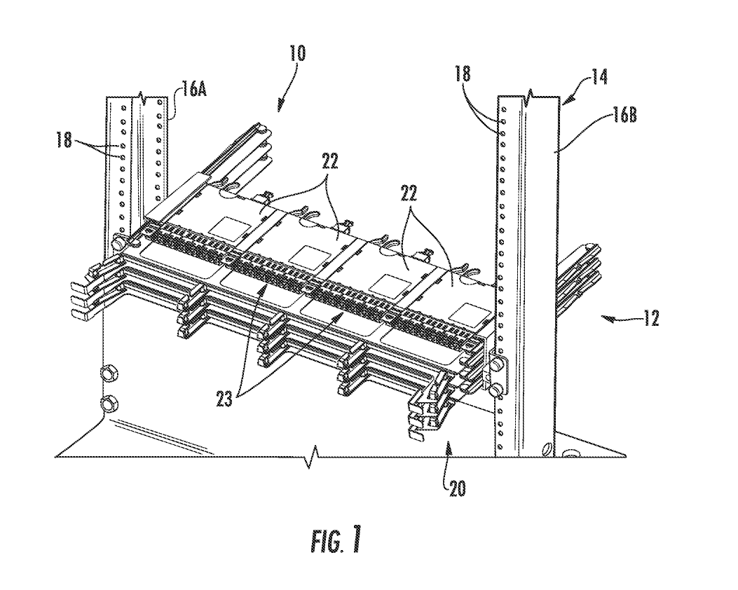

In this regard, FIG. 1 illustrates exemplary 1-U size fiber optic equipment 10 from a front perspective view. The fiber optic equipment 10 supports high-density fiber optic modules that support a high fiber optic connection density and bandwidth in a 1-U space, as will be described in greater detail below. The fiber optic equipment 10 may be provided at a data distribution center or central office to support cable-to-cable fiber optic connections and to manage a plurality of fiber optic cable connections. As will be described in greater detail below, the fiber optic equipment 10 has one or more fiber optic equipment trays that each support one or more fiber optic modules. However, the fiber optic equipment 10 could also be adapted to support one or more fiber optic patch panels or other fiber optic equipment that supports fiber optic components and connectivity.

The fiber optic equipment 10 includes a fiber optic equipment chassis 12 (“chassis 12”). The chassis 12 is shown as being installed in a fiber optic equipment rack 14. The fiber optic equipment rack 14 contains two vertical rails 16A, 16B that extend vertically and include a series of apertures 18 for facilitating attachment of the chassis 12 inside the fiber optic equipment rack 14. The chassis 12 is attached and supported by the fiber optic equipment rack 14 in the form of shelves that are stacked on top of each other within the vertical rails 16A, 16B. As illustrated, the chassis 12 is attached to the vertical rails 16A, 16B. The fiber optic equipment rack 14 may support 1-U-sized shelves, with “U” equal to a standard 1.75 inches in height and nineteen (19) inches in width. In certain applications, the width of “U” may be twenty-three (23) inches. Also, the term fiber optic equipment rack 14 should be understood to include structures that are cabinets as well. In this embodiment, the chassis 12 is 1-U in size; however, the chassis 12 could be provided in a size greater than 1-U as well.

As will be discussed in greater detail later below, the fiber optic equipment 10 includes a plurality of extendable fiber optic equipment trays 20 that each carries one or more fiber optic modules 22. The chassis 12 and fiber optic equipment trays 20 support fiber optic modules 22 that support high-density fiber optic modules and a fiber optic connection density and bandwidth connections in a given space, including in a 1-U space. FIG. 1 shows exemplary fiber optic components 23 disposed in the fiber optic modules 22 that support fiber optic connections. For example, the fiber optic components 23 may be fiber optic adapters or fiber optic connectors. As will also be discussed in greater detail later below, the fiber optic modules 22 in this embodiment can be provided such that the fiber optic components 23 can be disposed through at least eighty-five percent (85%) of the width of the front side or face of the fiber optic module 22, as an example. This fiber optic module 22 configuration may provide a front opening of approximately 90 millimeters (mm) or less wherein fiber optic components can be disposed through the front opening and at a fiber optic connection density of at least one fiber optic connection per 7.0 mm of width of the front opening of the fiber optic modules 22 for simplex or duplex fiber optic components 23. In this example, six (6) duplex or twelve (12) simplex fiber optic components may be installed in each fiber optic module 22. The fiber optic equipment trays 20 in this embodiment support up to four (4) of the fiber optic modules 22 in approximately the width of a 1-U space, and three (3) fiber optic equipment trays 20 in the height of a 1-U space for a total of twelve (12) fiber optic modules 22 in a 1-U space. Thus, for example, if six (6) duplex fiber optic components were disposed in each of the twelve (12) fiber optic modules 22 installed in fiber optic equipment trays 20 of the chassis 12 as illustrated in FIG. 1, a total of one hundred forty-four (144) fiber optic connections, or seventy-two (72) duplex channels (i.e., transmit and receive channels), would be supported by the chassis 12 in a 1-U space. If five (5) duplex fiber optic adapters are disposed in each of the twelve (12) fiber optic modules 22 installed in fiber optic equipment trays 20 of the chassis 12, a total of one hundred twenty (120) fiber optic connections, or sixty (60) duplex channels, would be supported by the chassis 12 in a 1-U space. The chassis 12 also supports at least ninety-eight (98) fiber optic components in a 1-U space wherein at least one of the fiber optic components is a simplex or duplex fiber optic component.

If multi-fiber fiber optic components were installed in the fiber optic modules 22, such as MPO components for example, higher fiber optic connection density and bandwidths would be possible over other chassis 12 that use similar fiber optic components. For example, if up to four (4) twelve (12) fiber MPO fiber optic components were disposed in each fiber optic module 22, and twelve (12) of the fiber optic modules 22 were disposed in the chassis 12 in a 1-U space, the chassis 12 would support up to five hundred seventy-six (576) fiber optic connections in a 1-U space. If up to four (4) twenty-four (24) fiber MPO fiber optic components were disposed in each fiber optic module 22, and twelve (12) of the fiber optic modules 22 were disposed in the chassis 12, up to one thousand one hundred fifty-two (1152) fiber optic connections in a 1-U space.

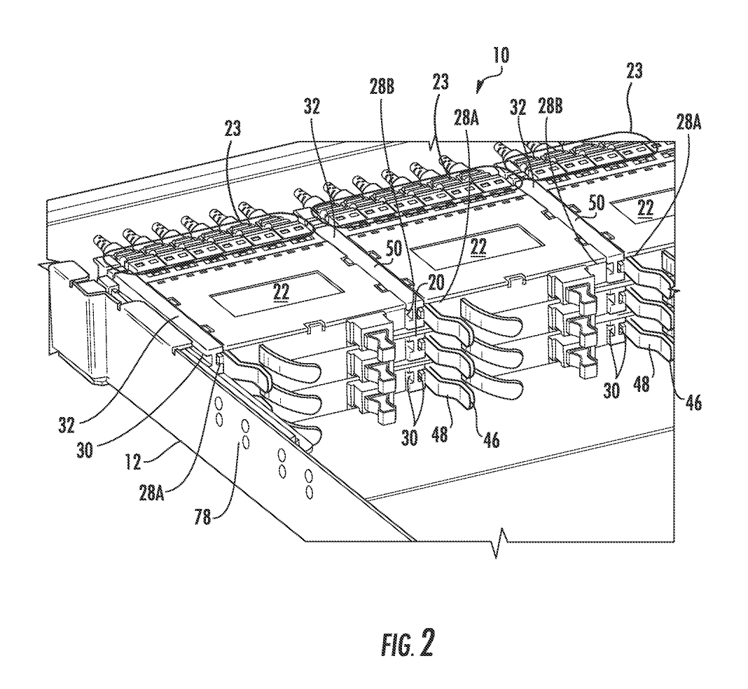

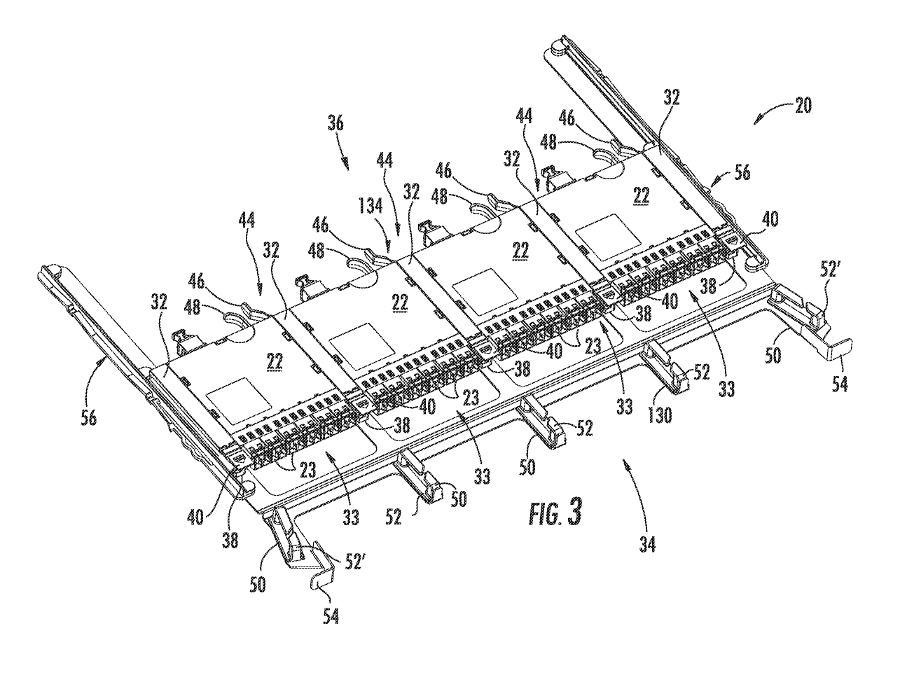

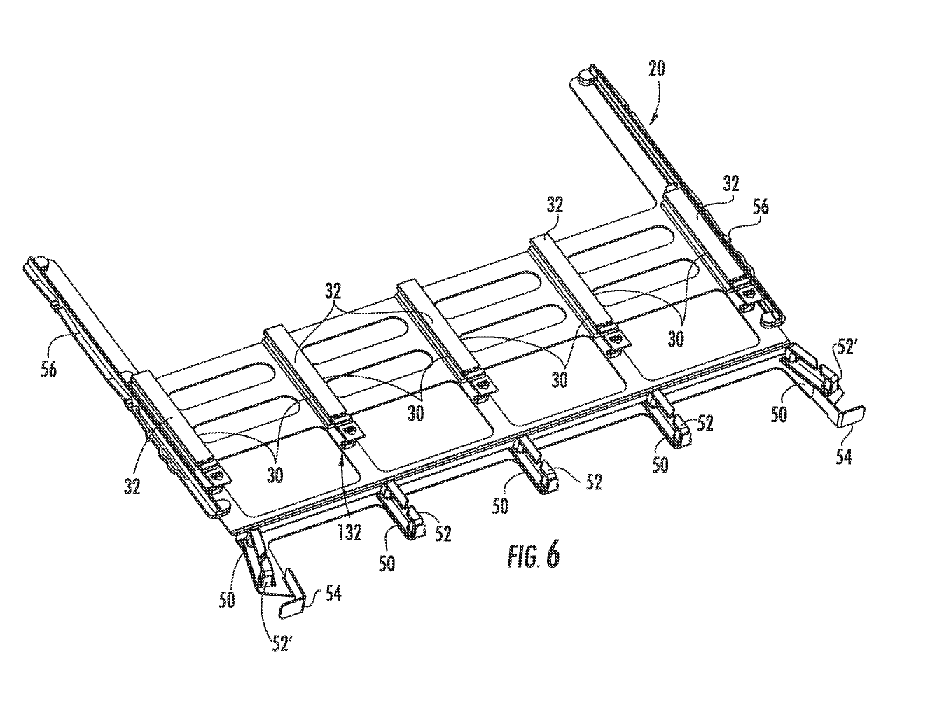

FIG. 2 is a rear perspective close-up view of the chassis 12 of FIG. 1 with fiber optic modules 22 loaded with fiber optic components 23 and installed in fiber optic equipment trays 20 installed in the chassis 12. Module rails 28A, 28B are disposed on each side of each fiber optic module 22. The module rails 28A, 28B are configured to be inserted within tray channels 30 of module rail guides 32 disposed in the fiber optic equipment tray 20, as illustrated in more detail in FIGS. 3-5. Note that any number of module rail guides 32 can be provided. The fiber optic module 22 can be installed from both a front end 34 and a rear end 36 of the fiber optic equipment tray 20 in this embodiment. If it is desired to install the fiber optic module 22 in the fiber optic equipment tray 20 from the rear end 36, a front end 33 of the fiber optic module 22 can be inserted from the rear end 36 of the fiber optic equipment tray 20. More specifically, the front end 33 of the fiber optic module 22 is inserted into the tray channels 30 of the module rail guides 32. The fiber optic module 22 can then be pushed forward within the tray channels 30 until the fiber optic module 22 reaches the front end 34 of the module rail guides 32. The fiber optic modules 22 can be moved towards the front end 34 until the fiber optic modules 22 reach a stop or locking feature disposed in the front end 34 as will described later in this application. FIG. 6 also illustrates the fiber optic equipment tray 20 without installed fiber optic modules 22 to illustrate the tray channels 30 and other features of the fiber optic equipment tray 20.

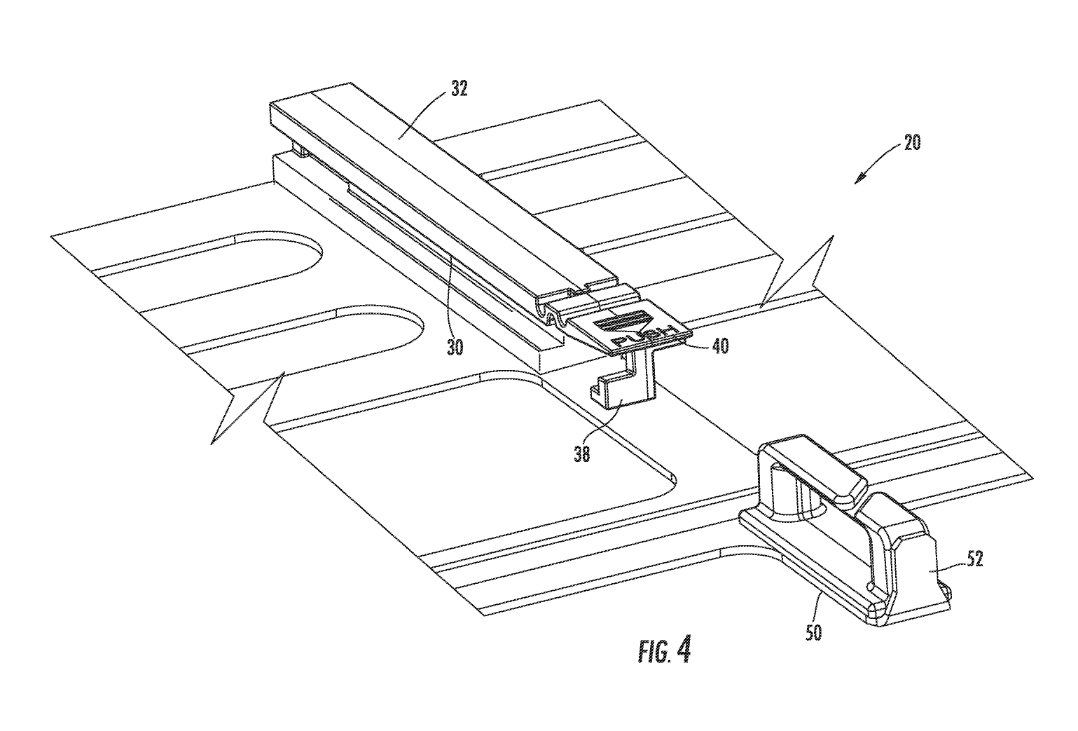

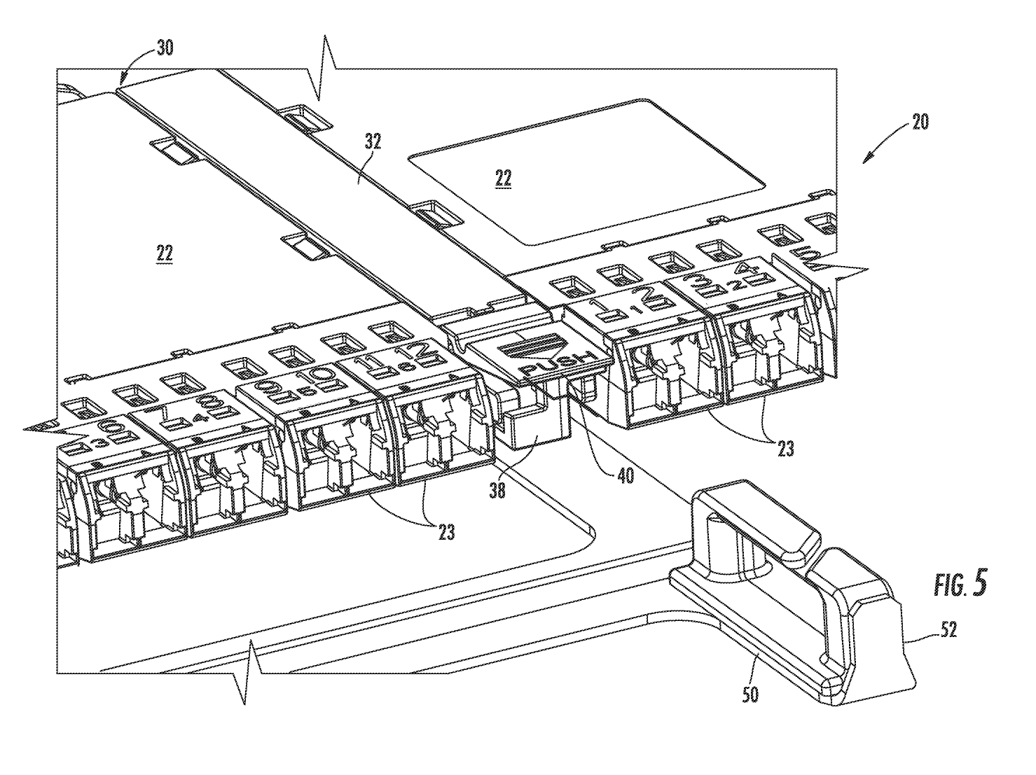

The fiber optic module 22 can be locked into place in the fiber optic equipment tray 20 by pushing the fiber optic module 22 forward to the front end 33 of the fiber optic equipment tray 20. A locking feature in the form of a front stop 38 is disposed in the module rail guides 32, as illustrated in FIG. 3 and in more detail in the close-up view in FIG. 4. The front stop 38 prevents the fiber optic module 22 from extending beyond the front end 34, as illustrated in the close-up view of the fiber optic equipment tray 20 with installed fiber optic modules 22 in FIG. 5. When it is desired to remove a fiber optic module 22 from the fiber optic equipment tray 20, a front module tab 40 also disposed in the module rail guides 32 and coupled to the front stop 38 can be pushed downward to engage the front stop 38. As a result, the front stop 38 will move outward away from the fiber optic module 22 such that the fiber optic module 22 is not obstructed from being pulled forward. The fiber optic module 22, and in particular its module rails 28A, 28B (FIG. 2), can be pulled forward along the module rail guides 32 to remove the fiber optic module 22 from the fiber optic equipment tray 20.

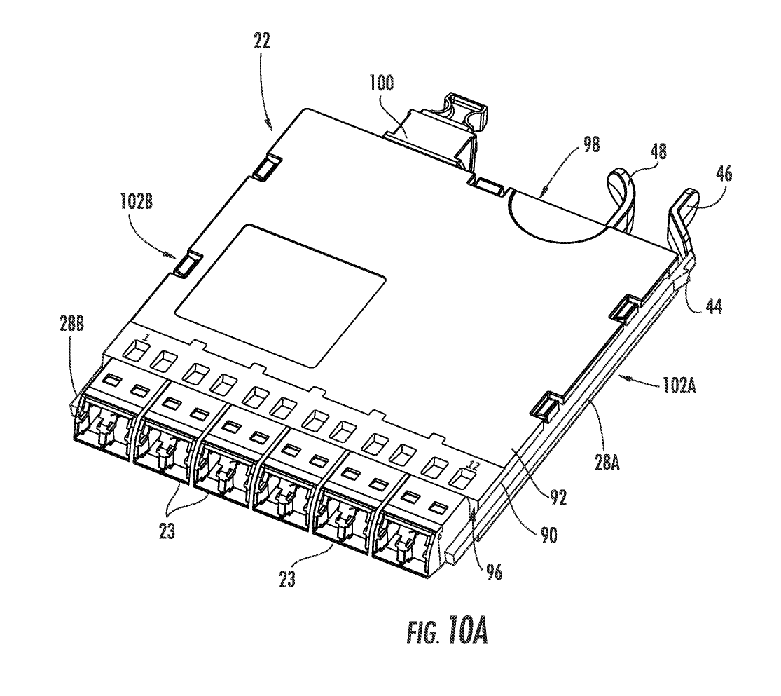

The fiber optic module 22 can also be removed from the rear end 36 of the fiber optic equipment tray 20. To remove the fiber optic module 22 from the rear end 36 of the fiber optic equipment tray 20, a latch 44 is disengaged by pushing a lever 46 (see FIGS. 2 and 3; see also, FIGS. 10A and 10B) inward towards the fiber optic module 22 to release the latch 44 from the module rail guide 32. To facilitate pushing the lever 46 inward towards the fiber optic module 22, a finger hook 48 is provided adjacent to the lever 46 so the lever 46 can easily be squeezed into the finger hook 48 by a thumb and index finger.

With continuing reference to FIG. 3-6, the fiber optic equipment tray 20 may also contain extension members 50. Routing guides 52 may be conveniently disposed on the extension members 50 to provide routing for optical fibers or fiber optic cables connected to fiber optic components 23 disposed in the fiber optic modules 22 (FIG. 3). The routing guides 52′ on the ends of the fiber optic equipment tray 20 may be angled with respect to the module rail guides 32 to route optical fibers or fiber optic cables at an angle to the sides of the fiber optic equipment tray 20. Pull tabs 54 may also be connected to the extension members 50 to provide a means to allow the fiber optic equipment tray 20 to easily be pulled out from and pushed into the chassis 12.

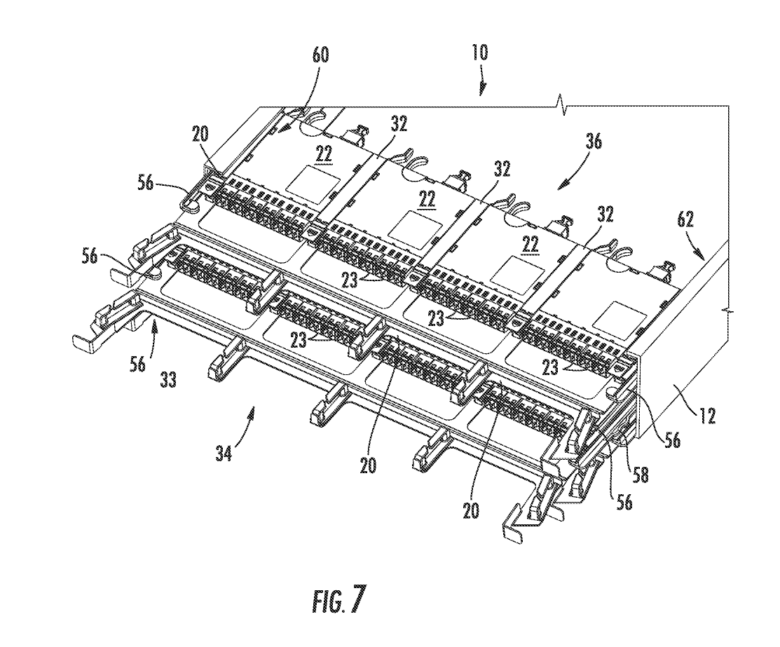

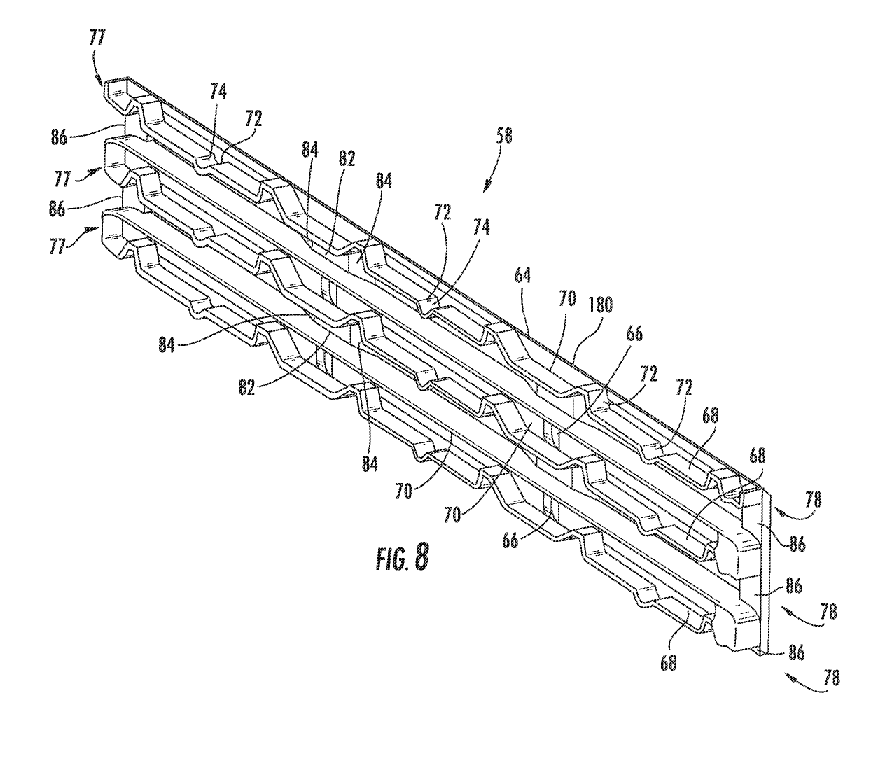

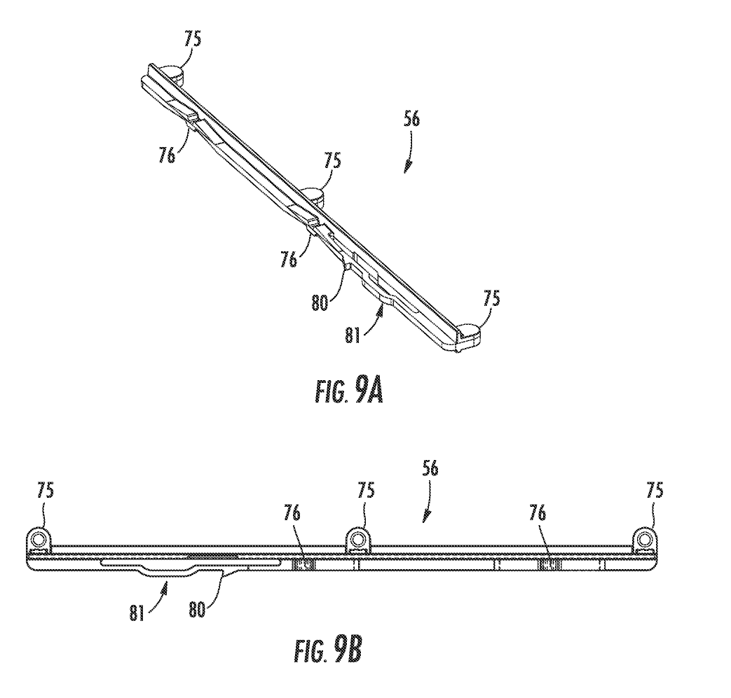

As illustrated in FIGS. 3 and 6, the fiber optic equipment tray 20 also contains tray rails 56. The tray rails 56 are configured to be received in tray guides 58 disposed in the chassis 12 to retain and allow the fiber optic equipment trays 20 to move in and out of the chassis 12, as illustrated in FIG. 7. More detail regarding the tray rails 56 and their coupling to the tray guides 58 in the chassis 12 is discussed below with regard to FIGS. 8 and 9A-9B. The fiber optic equipment trays 20 can be moved in and out of the chassis 12 by their tray rails 56 moving within the tray guides 58. In this manner, the fiber optic equipment trays 20 can be independently movable about the tray guides 58 in the chassis 12. FIG. 7 illustrates a front perspective view of one fiber optic equipment tray 20 pulled out from the chassis 12 among three (3) fiber optic equipment trays 20 disposed within the tray guides 58 of the chassis 12. The tray guides 58 may be disposed on both a left side end 60 and a right side end 62 of the fiber optic equipment tray 20. The tray guides 58 are installed opposite and facing each other in the chassis 12 to provide complementary tray guides 58 for the tray rails 56 of the fiber optic equipment trays 20 received therein. If it is desired to access a particular fiber optic equipment tray 20 and/or a particular fiber optic module 22 in a fiber optic equipment tray 20, the pull tab 54 of the desired fiber optic equipment tray 20 can be pulled forward to cause the fiber optic equipment tray 20 to extend forward out from the chassis 12, as illustrated in FIG. 7. The fiber optic module 22 can be removed from the fiber optic equipment tray 20 as previously discussed. When access is completed, the fiber optic equipment tray 20 can be pushed back into the chassis 12 wherein the tray rails 56 move within the tray guides 58 disposed in the chassis 12.

FIG. 8 is a left perspective view of an exemplary tray guide 58 disposed in the chassis 12 of FIG. 1. As discussed above, the tray guides 58 are configured to receive fiber optic equipment trays 20 supporting one or more fiber optic modules 22 in the chassis 12. The tray guides 58 allow the fiber optic equipment trays 20 to be pulled out from the chassis 12, as illustrated in FIG. 7. The tray guide 58 in this embodiment is comprised of a guide panel 64. The guide panel 64 may be constructed out of any material desired, including but not limited to a polymer or metal. The guide panel 64 contains a series of apertures 66 to facilitate attachment of the guide panel 64 to the chassis 12, as illustrated in FIG. 8. Guide members 68 are disposed in the guide panel 64 and configured to receive the tray rail 56 of the fiber optic equipment tray 20. Three (3) guide members 68 are disposed in the guide panel 64 in the embodiment of FIG. 8 to be capable of receiving up to three (3) tray rails 56 of three (3) fiber optic equipment trays 20 in a 1-U space. However, any number of guide members 68 desired may be provided in the tray guide 58 to cover sizes less than or greater than a 1-U space. In this embodiment, the guide members 68 each include guide channels 70 configured to receive and allow tray rails 56 to move along the guide channels 70 for translation of the fiber optic equipment trays 20 about the chassis 12.

Leaf springs 72 are disposed in each of the guide members 68 of the tray guide 58 and are each configured to provide stopping positions for the tray rails 56 during movement of the fiber optic equipment tray 20 in the guide members 68. The leaf springs 72 each contain detents 74 that are configured to receive protrusions 76 (FIG. 9A-9D) disposed in the tray rails 56 to provide stopping or resting positions. The tray rails 56 contain mounting platforms 75 that are used to attach the tray rails 56 to the fiber optic equipment trays 20. It may be desirable to provide stopping positions in the tray guide 56 to allow the fiber optic equipment trays 20 to have stopping positions when moved in and out of the chassis 12. Two (2) protrusions 76 in the tray rail 56 are disposed in two (2) detents 74 in the tray guide 58 at any given time. When the fiber optic equipment tray 20 is fully retracted into the chassis 12 in a first stopping position, the two (2) protrusions 76 of the tray rail 56 are disposed in the one detent 74 adjacent a rear end 77 of the guide channel 70 and the middle detent 74 disposed between the rear end 77 and a front end 78 of the guide channel 70. When the fiber optic equipment tray 20 is pulled out from the chassis 12, the two (2) protrusions 76 of the tray rail 56 are disposed in the one detent 74 adjacent the front end 78 of the guide channel 70 and the middle detent 74 disposed between the rear end 77 and the front end 78 of the guide channel 70.

As the tray rail 56 is pulled within the guide channel 70, a protrusion 80 disposed in the tray rail 56 and illustrated in FIGS. 9A and 9B is biased to pass over transition members 82 disposed between the leaf springs 72, as illustrated in FIG. 8. The protrusion 80 is provided in a leaf spring 81 disposed in the tray rail 56, as illustrated in FIGS. 9A and 9B. The transition members 82 have inclined surfaces 84 that allow the protrusion 80 to pass over the transition members 82 as the fiber optic equipment tray 20 is being translated with the guide channel 70. As the protrusion 80 contains the transition members 82, the force imparted onto the protrusion 80 causes the leaf spring 81 to bend inward to allow the protrusion 80 to pass over the transition member 82. To prevent the tray rail 56 and thus the fiber optic equipment tray 20 from being extended beyond the front end 78 and rear end 77 of the guide channel 70, stopping members 86 are disposed at the front end 78 and rear end 77 of the guide channel 70. The stopping members 86 do not have an inclined surface; thus the protrusion 80 in the tray rail 56 abuts against the stopping member 86 and is prevented from extending over the stopping member 86 and outside of the front end 78 of the guide channel 70.

Against the background of the above disclosed embodiment of a 1-U chassis 12 and fiber optic equipment trays 20 and fiber optic modules 22 that can installed therein, the form factor of the fiber optic module 22 will now be described. The form factor of the fiber optic module 22 allows a high density of fiber optic components 23 to be disposed within a certain percentage area of the front of the fiber optic module 22 thus supporting a particular fiber optic connection density and bandwidth for a given type of fiber optic component 23. When this fiber optic module 22 form factor is combined with the ability to support up to twelve (12) fiber optic modules 22 in a 1-U space, as described by the exemplary chassis 12 example above, a higher fiber optic connection density and bandwidth is supported and possible.

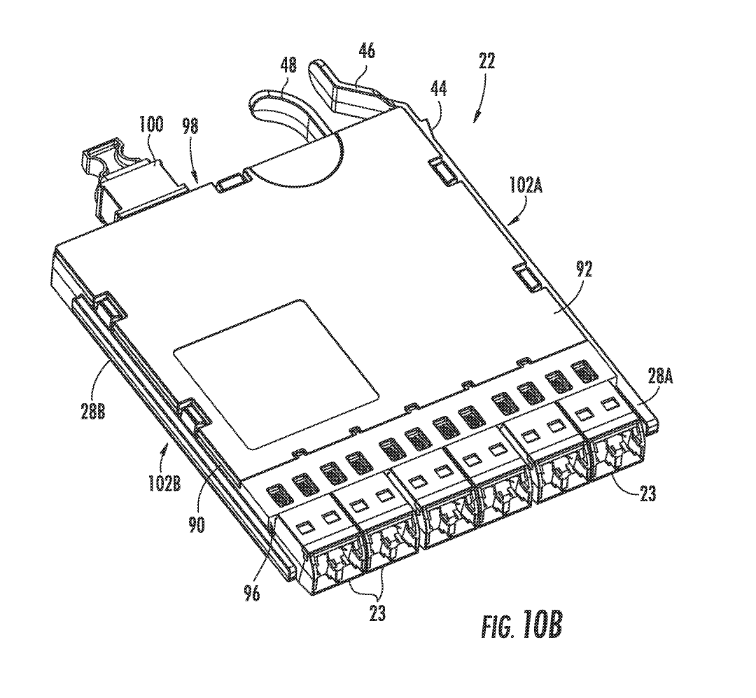

In this regard, FIGS. 10A and 10B are right and left perspective views of the exemplary fiber optic module 22. As discussed above, the fiber optic module 22 can be installed in the fiber optic equipment trays 20 to provide fiber optic connections in the chassis 12. The fiber optic module 22 is comprised of a main body 90 receiving a cover 92. An internal chamber 94 (FIG. 11) disposed inside the main body 90 and the cover 92 and is configured to receive or retain optical fibers or a fiber optic cable harness, as will be described in more detail below. The main body 90 is disposed between a front side 96 and a rear side 98 of the main body 90. Fiber optic components 23 can be disposed through the front side 96 of the main body 90 and configured to receive fiber optic connectors connected to fiber optic cables (not shown). In this example, the fiber optic components 23 are duplex LC fiber optic adapters that are configured to receive and support connections with duplex LC fiber optic connectors. However, any fiber optic connection type desired can be provided in the fiber optic module 22. The fiber optic components 23 are connected to a fiber optic component 100 disposed through the rear side 98 of the main body 90. In this manner, a connection to the fiber optic component 23 creates a fiber optic connection to the fiber optic component 100. In this example, the fiber optic component 100 is a multi-fiber MPO fiber optic adapter equipped to establish connections to multiple optical fibers (e.g., either twelve (12) or twenty-four (24) optical fibers). The fiber optic module 22 may also manage polarity between the fiber optic components 23, 100.

The module rails 28A, 28B are disposed on each side 102A, 102B of the fiber optic module 22. As previously discussed, the module rails 28A, 28B are configured to be inserted within the module rail guides 32 in the fiber optic equipment tray 20, as illustrated in FIG. 3. In this manner, when it is desired to install a fiber optic module 22 in the fiber optic equipment tray 20, the front side 96 of the fiber optic module 22 can be inserted from either the front end 33 or the rear end 36 of the fiber optic equipment tray 20, as previously discussed.

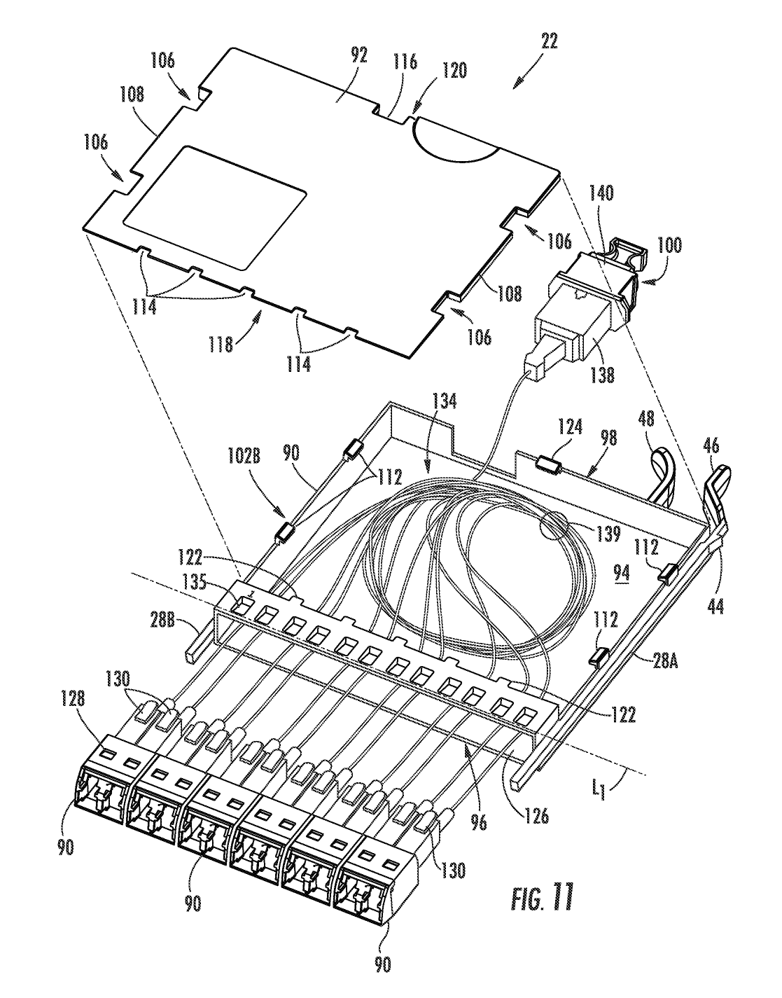

FIG. 11 illustrates the fiber optic module 22 in an exploded view with the cover 92 of the fiber optic module 22 removed to illustrate the internal chamber 94 and other internal components of the fiber optic module 22. FIG. 12 illustrates the fiber optic module 22 assembled, but without the cover 92 installed on the main body 90. The cover 92 includes notches 106 disposed in sides 108, 110 that are configured to interlock with protrusions 112 disposed on the sides 102A, 102B of the main body 90 of the fiber optic modules 22 when the cover 92 is attached to the main body 90 to secure the cover 92 to the main body 90. The cover 92 also contains notches 114, 116 disposed on a front side 118 and rear side 120, respectively, of the cover 92. The notches 114, 116 are configured to interlock with protrusions 122, 124 disposed in the front side 96 and the rear end 98, respectively, of the main body 90 when the cover 92 is attached to the main body 90 to also secure the cover 92 to the main body 90. FIG. 12 does not show protrusions 122, 124.

With continuing reference to FIG. 11, the fiber optic components 23 are disposed through a front opening 126 disposed along a longitudinal axis L₁ in the front side 96 of the main body 90. In this embodiment, the fiber optic components 23 are duplex LC adapters 128, which support single or duplex fiber connections and connectors. The duplex LC adapters 128 in this embodiment contain protrusions 130 that are configured to engage with orifices 135 disposed on the main body 90 to secure the duplex LC adapters 128 in the main body 90 in this embodiment. A cable harness 134 is disposed in the internal chamber 94 with fiber optic connectors 136, 138 disposed on each end of optical fibers 139 connected to the duplex LC adapters 128 and the fiber optic component 100 disposed in the rear side 98 of the main body 90. The fiber optic component 100 in this embodiment is a twelve (12) fiber MPO fiber optic adapter 140 in this embodiment. Two vertical members 142A, 142B are disposed in the internal chamber 94 of the main body 90, as illustrated in FIG. 12, to retain the looping of the optical fibers 139 of the cable harness 134. The vertical members 142A, 142B and the distance therebetween are designed to provide a bend radius R in the optical fibers 139 no greater than forty (40) mm and preferably twenty-five (25) mm or less in this embodiment.

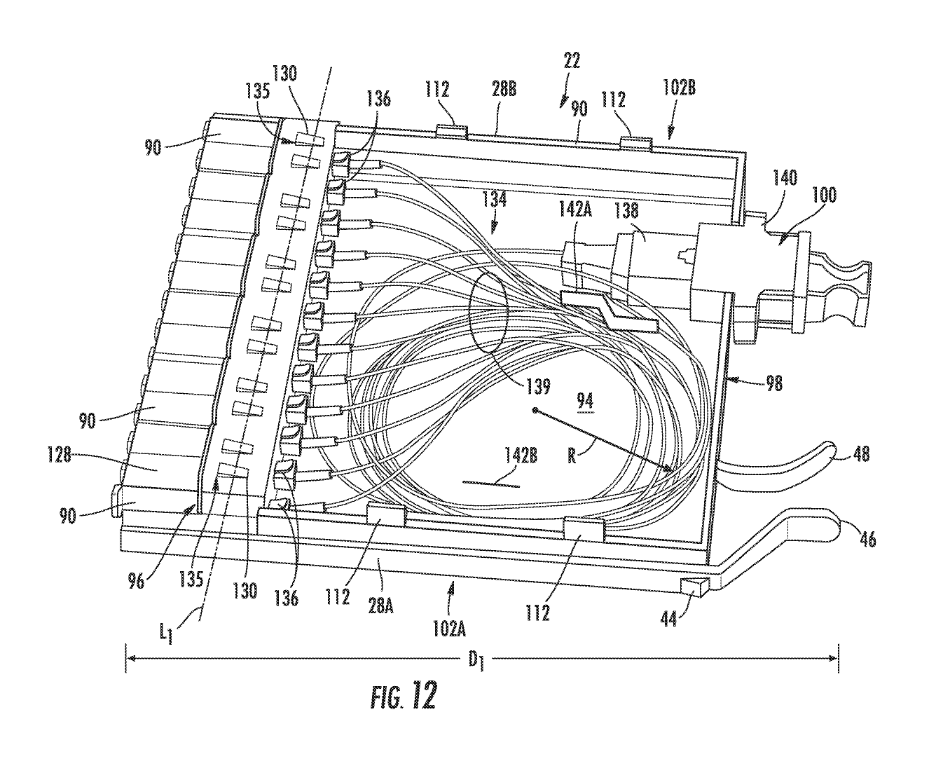

FIG. 13 illustrates a front view of the fiber optic module 22 without loaded fiber optic components 23 in the front side 96 to further illustrate the form factor of the fiber optic module 22. As previously discussed, the front opening 126 is disposed through the front side 96 of the main body 90 to receive the fiber optic components 23. The greater the width W₁ of the front opening 126, the greater the number of fiber optic components 23 that may be disposed in the fiber optic module 22. Greater numbers of fiber optic components 23 equates to more fiber optic connections, which supports higher fiber optic connectivity and bandwidth. However, the larger the width W₁ of the front opening 126, the greater the area required to be provided in the chassis 12 for the fiber optic module 22. Thus, in this embodiment, the width W₁ of the front opening 126 is design to be at least eighty-five percent (85%) of the width W₂ of the front side 96 of the main body 90 of the fiber optic module 22. The greater the percentage of the width W₁ to width W₂, the larger the area provided in the front opening 126 to receive fiber optic components 23 without increasing width W₂. Width W₃, the overall width of the fiber optic module 22, may be 86.6 mm or 3.5 inches in this embodiment. The overall depth D₁ of the fiber optic module 22 is 113.9 mm or 4.5 inches in this embodiment (FIG. 12). As previously discussed, the fiber optic module 22 is designed such that four (4) fiber optic modules 22 can be disposed in a 1-U width space in the fiber optic equipment tray 20 in the chassis 12. The width of the chassis 12 is designed to accommodate a 1-U space width in this embodiment.

With three (3) fiber optic equipment trays 20 disposed in the 1-U height of the chassis 12, a total of twelve (12) fiber optic modules 22 can be supported in a given 1-U space. Supporting up to twelve (12) fiber optic connections per fiber optic module 22 as illustrated in the chassis 12 in FIG. 1 equates to the chassis 12 supporting up to one hundred forty-four (144) fiber optic connections, or seventy-two (72) duplex channels, in a 1-U space in the chassis 12 (i.e., twelve (12) fiber optic connections×twelve (12) fiber optic modules 22 in a 1-U space). Thus, the chassis 12 is capable of supporting up to one hundred forty-four (144) fiber optic connections in a 1-U space by twelve (12) simplex or six (6) duplex fiber optic adapters being disposed in the fiber optic modules 22. Supporting up to ten (10) fiber optic connections per fiber optic module 22 equates to the chassis 12 supporting one hundred twenty (120) fiber optic connections, or sixty (60) duplex channels, in a 1-U space in the chassis 12 (i.e., ten (10) fiber optic connections×twelve (12) fiber optic modules 22 in a 1-U space). Thus, the chassis 12 is also capable of supporting up to one hundred twenty (120) fiber optic connections in a 1-U space by ten (10) simplex or five (5) duplex fiber optic adapters being disposed in the fiber optic modules 22.

This embodiment of the chassis 12 and fiber optic module 22 disclosed herein can support a fiber optic connection density within a 1-U space wherein the area occupied by the fiber optic component 23 in twelve (12) fiber optic modules 22 in a 1-U space represents at least fifty percent (50%) of the total fiber optic equipment rack 14 area in a 1-U space (see FIG. 1). In the case of twelve (12) fiber optic modules 22 provided in a 1-U space in the chassis 12, the 1-U space is comprised of the fiber optic components 23 occupying at least seventy-five percent (75%) of the area of the front side 96 of the fiber optic module 22.

Two (2) duplexed optical fibers to provide one (1) transmission/reception pair can allow for a data rate of ten (10) Gigabits per second in half-duplex mode or twenty (20) Gigabits per second in full-duplex mode. Thus, with the above-described embodiment, providing at least seventy-two (72) duplex transmission and reception pairs in a 1-U space employing at least one duplex or simplex fiber optic component can support a data rate of at least seven hundred twenty (720) Gigabits per second in half-duplex mode in a 1-U space or at least one thousand four hundred forty (1440) Gigabits per second in a 1-U space in full-duplex mode if employing a ten (10) Gigabit transceiver. This configuration can also support at least six hundred (600) Gigabits per second in half-duplex mode in a 1-U space and at least one thousand two hundred (1200) Gigabits per second in full-duplex mode in a 1-U space, respectively, if employing a one hundred (100) Gigabit transceiver. This configuration can also support at least four hundred eighty (480) Gigabits per second in half-duplex mode in a 1-U space and nine hundred sixty (960) Gigabits per second in full duplex mode in a 1-U space, respectively, if employing a forty (40) Gigabit transceiver. At least sixty (60) duplex transmission and reception pairs in a 1-U space can allow for a data rate of at least six hundred (600) Gigabits per second in a 1-U space in half-duplex mode or at least one thousand two hundred (1200) Gigabits per second in a 1-U space in full-duplex mode when employing a ten (10) Gigabit transceiver. At least forty nine (49) duplex transmission and reception pairs in a 1-U space can allow for a data rate of at least four hundred eighty-one (481) Gigabits per second in half-duplex mode or at least nine hundred sixty-two (962) Gigabits per second in a 1-U space in full-duplex mode when employing a ten (10) Gigabit transceiver.

The width W₁ of front opening 126 could be designed to be greater than eighty-five percent (85%) of the width W₂ of the front side 96 of the main body 90 of the fiber optic module 22. For example, the width W₁ could be designed to be between ninety percent (90%) and ninety-nine percent (99%) of the width W₂. As an example, the width W₁ could be less than ninety (90) mm. As another example, the width W₁ could be less than eighty-five (85) mm or less than eighty (80) mm. For example, the width W₁ may be eighty-three (83) mm and width W₂ may be eighty-five (85) mm, for a ratio of width W₁ to width W₂ of 97.6%. In this example, the front opening 126 may support twelve (12) fiber optic connections in the width W₁ to support a fiber optic connection density of at least one fiber optic connection per 7.0 mm of width W₁ of the front opening 126. Further, the front opening 126 of the fiber optic module 22 may support twelve (12) fiber optic connections in the width W₁ to support a fiber optic connection density of at least one fiber optic connection per 6.9 mm of width W₁ of the front opening 126.

Further as illustrated in FIG. 13, height H₁ of front opening 126 could be designed to be at least ninety percent (90%) of height H₂ of the front side 96 of the main body 90 of the fiber optic module 22. In this manner, the front opening 126 has sufficient height to receive the fiber optic components 23, and such that three (3) fiber optic modules 22 can be disposed in a 1-U space height. As an example, height H₁ could be twelve (12) mm or less or ten (10) mm or less. As an example, height H₁ could be ten (10) mm and height H₂ could be eleven (11) mm (or 7/16 inches), for a ratio of height H₁ to width H₂ of 90.9%.

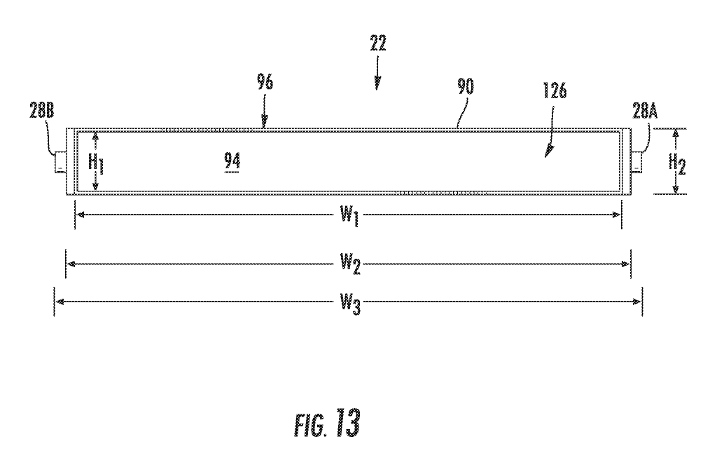

Alternate fiber optic modules with alternative fiber optic connection densities are possible. FIG. 14 is a front perspective view of an alternate fiber optic module 22′ that can be installed in the fiber optic equipment tray 20 of FIG. 1. The form factor of the fiber optic module 22′ is the same as the form factor of the fiber optic module 22 illustrated in FIGS. 1-13. However, in the fiber optic module 22′ of FIG. 14, two (2) MPO fiber optic adapters 150 are disposed through the front opening 126 of the fiber optic module 22′. The MPO fiber optic adapters 150 are connected to two (2) MPO fiber optic adapters 152 disposed in the rear side 98 of the main body 90 of the fiber optic module 22′. Thus, if the MPO fiber optic adapters 150 each support twelve (12) fibers, the fiber optic module 22′ can support up to twenty-four (24) fiber optic connections. Thus, in this example, if up to twelve (12) fiber optic modules 22′ are provided in the fiber optic equipment trays 20 of the chassis 12, up to two hundred eighty-eight (288) fiber optic connections can be supported by the chassis 12 in a 1-U space. Further in this example, the front opening 126 of the fiber optic module 22′ may support twenty-four (24) fiber optic connections in the width W₁ (FIG. 13) to support a fiber optic connection density of at least one fiber optic connection per 3.4-3.5 mm of width W₁ of the front opening 126. It should be understood that the discussion with regard to modules may also apply to a panel. For purposes of this disclosure, a panel may have one or more adapter on one side and no adapters on the opposite side.

Thus, with the above-described embodiment, providing at least two-hundred eighty-eight (288) duplex transmission and reception pairs in a 1-U space employing at least one twelve (12) fiber MPO fiber optic components can support a data rate of at least two thousand eight hundred eighty (2880) Gigabits per second in half-duplex mode in a 1-U space or at least five thousand seven hundred sixty (5760) Gigabits per second in a 1-U space in full-duplex mode if employing a ten (10) Gigabit transceiver. This configuration can also support at least four thousand eight hundred (4800) Gigabits per second in half-duplex mode in a 1-U space and nine thousand six hundred (9600) Gigabits per second in full-duplex mode in a 1-U space, respectively, if employing a one hundred (100) Gigabit transceiver. This configuration can also support at least one thousand nine hundred twenty (1920) Gigabits per second in half-duplex mode in a 1-U space and three thousand eight hundred forty (3840) Gigabits per second in full-duplex mode in a 1-U space, respectively, if employing a forty (40) Gigabit transceiver. This configuration also supports a data rate of at least four thousand three hundred twenty-two (4322) Gigabits per second in full-duplex mode in a 1-U space when employing a ten (10) Gigabit transceiver employing at least one twelve (12) fiber MPO fiber optic component, or two thousand one hundred sixty-one (2161) Gigabits per second in full-duplex mode in a 1-U space when employing a ten (10) Gigabit transceiver employing at least one twenty-four (24) fiber MPO fiber optic component.

If the MPO fiber optic adapters 150 in the fiber optic module 22′ support twenty-four (24) fibers, the fiber optic module 22′ can support up to forty-eight (48) fiber optic connections. Thus, in this example, if up to twelve (12) fiber optic modules 22′ are provided in the fiber optic equipment trays 20 of the chassis 12, up to five hundred seventy-six (576) fiber optic connections can be supported by the chassis 12 in a 1-U space if the fiber optic modules 22′ are disposed in the fiber optic equipment trays 20. Further, in this example, the front opening 126 of the fiber optic module 22′ may support up to forty-eight (48) fiber optic connections in the width W₁ to support a fiber optic connection density of at least one fiber optic connection per 1.7 mm of width W₁ of the front opening 126.

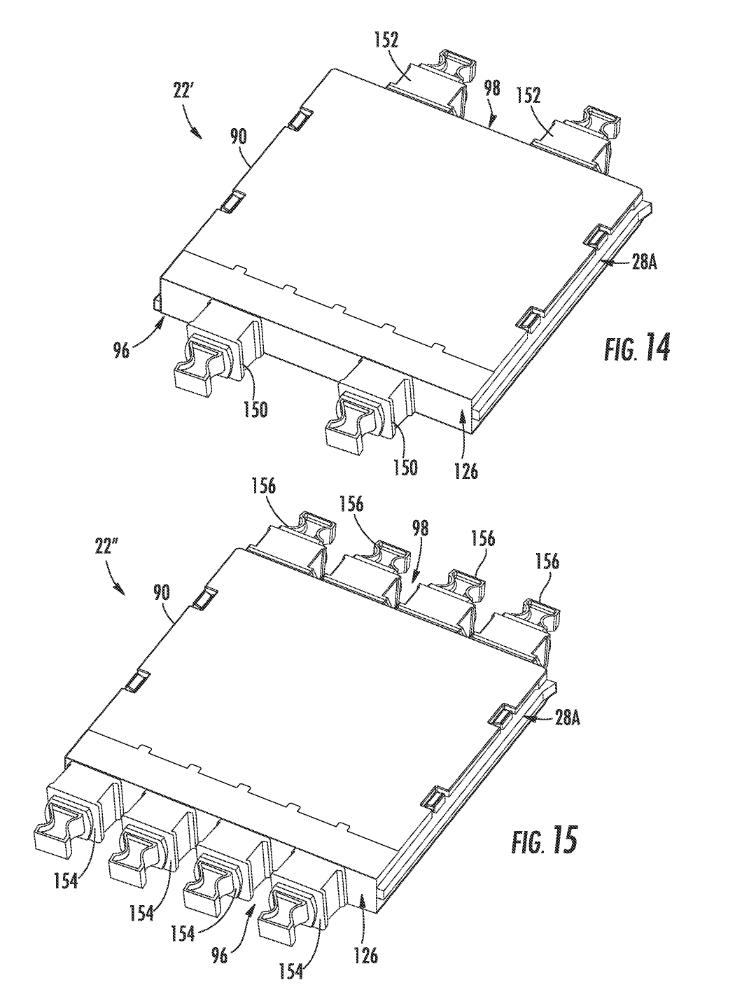

FIG. 15 is a front perspective view of another alternate fiber optic module 22″ that can be installed in the fiber optic equipment tray 20 of FIG. 1. The form factor of the fiber optic module 22″ is the same as the form factor of the fiber optic module 22 illustrated in FIGS. 1-13. However, in the fiber optic module 22″, four (4) MPO fiber optic adapters 154 are disposed through the front opening 126 of the fiber optic module 22″. The MPO fiber optic adapters 154 are connected to four (4) MPO fiber optic adapters 156 disposed in the rear end 98 of the main body 90 of the fiber optic module 22′. Thus, if the MPO fiber optic adapters 150 support twelve (12) fibers, the fiber optic module 22″ can support up to forty-eight (48) fiber optic connections. Thus, in this example, if up to twelve (12) fiber optic modules 22″ are provided in the fiber optic equipment trays 20 of the chassis 12, up to five hundred seventy-six (756) fiber optic connections can be supported by the chassis 12 in a 1-U space. Further in this example, the front opening 126 of the fiber optic module 22″ may support twenty-four (24) fiber optic connections in the width W₁ to support a fiber optic connection density of at least one fiber optic connection per 1.7 mm of width W₁ of the front opening 126.

If the four (4) MPO fiber optic adapters 154 disposed in the fiber optic module 22″ support twenty-four (24) fibers, the fiber optic module 22″ can support up to ninety-six (96) fiber optic connections. Thus, in this example, if up to twelve (12) fiber optic modules 22″ are provided in the fiber optic equipment trays 20 of the chassis 12, up to one thousand one hundred fifty-two (1152) fiber optic connections can be supported by the chassis 12 in a 1-U space. Further, in this example, the front opening 126 of the fiber optic module 22″ may support up to ninety-six (96) fiber optic connections in the width W₁ to support a fiber optic connection density of at least one fiber optic connection per 0.85 mm of width W₁ of the front opening 126.

Further, with the above-described embodiment, providing at least five hundred seventy-six (576) duplex transmission and reception pairs in a 1-U space employing at least one twenty-four (24) fiber MPO fiber optic component can support a data rate of at least five thousand seven hundred sixty (5760) Gigabits per second in half-duplex mode in a 1-U space or at least eleven thousand five hundred twenty (11520) Gigabits per second in a 1-U space in full-duplex mode if employing a ten (10) Gigabit transceiver. This configuration can also support at least four thousand eight hundred (4800) Gigabits per second in half-duplex mode in a 1-U space and at least nine thousand six hundred (9600) Gigabits per second in full-duplex mode in a 1-U space, respectively, if employing a one hundred (100) Gigabit transceiver. This configuration can also support at least three thousand eight hundred forty (3840) Gigabits per second in half-duplex mode in a 1-U space and at least seven thousand six hundred eighty (7680) Gigabits per second in full-duplex mode in a 1-U space, respectively, if employing a forty (40) Gigabit transceiver. This configuration also supports a data rate of at least eight thousand six hundred forty two (8642) Gigabits per second in full-duplex mode in a 1-U space when employing a ten (10) Gigabit transceiver employing at least one twenty-four (24) fiber MPO fiber optic component, or four thousand three hundred twenty one (4321) Gigabits per second in full-duplex mode in a 1-U space when employing a ten (10) Gigabit transceiver employing at least one twenty-four (24) fiber MPO fiber optic component.

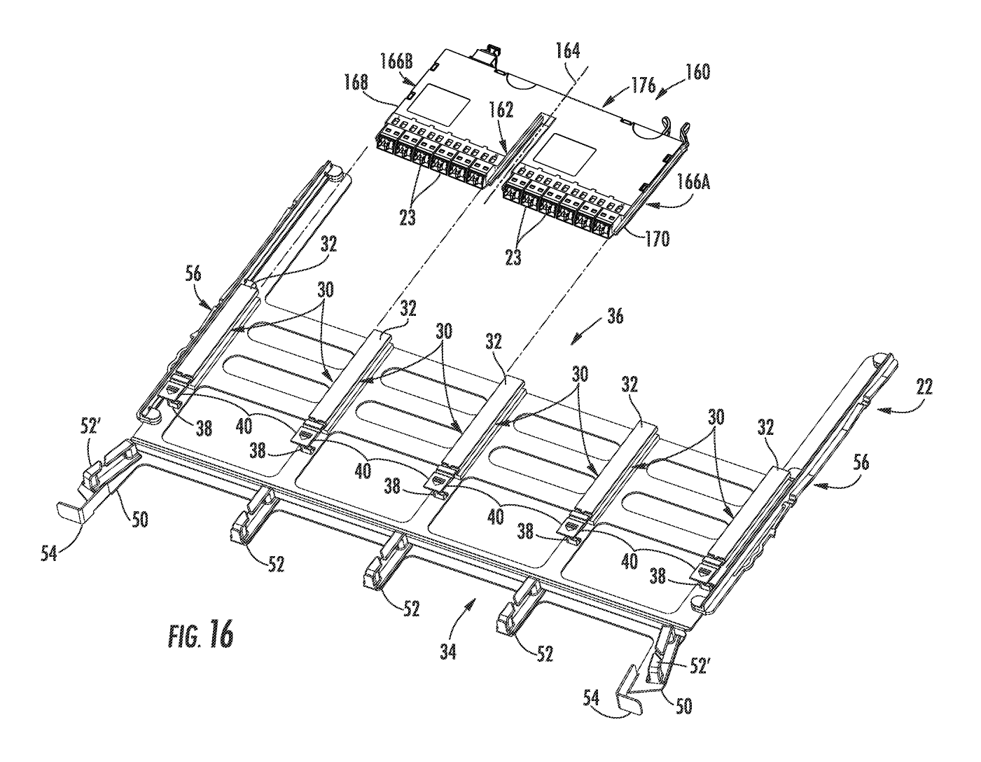

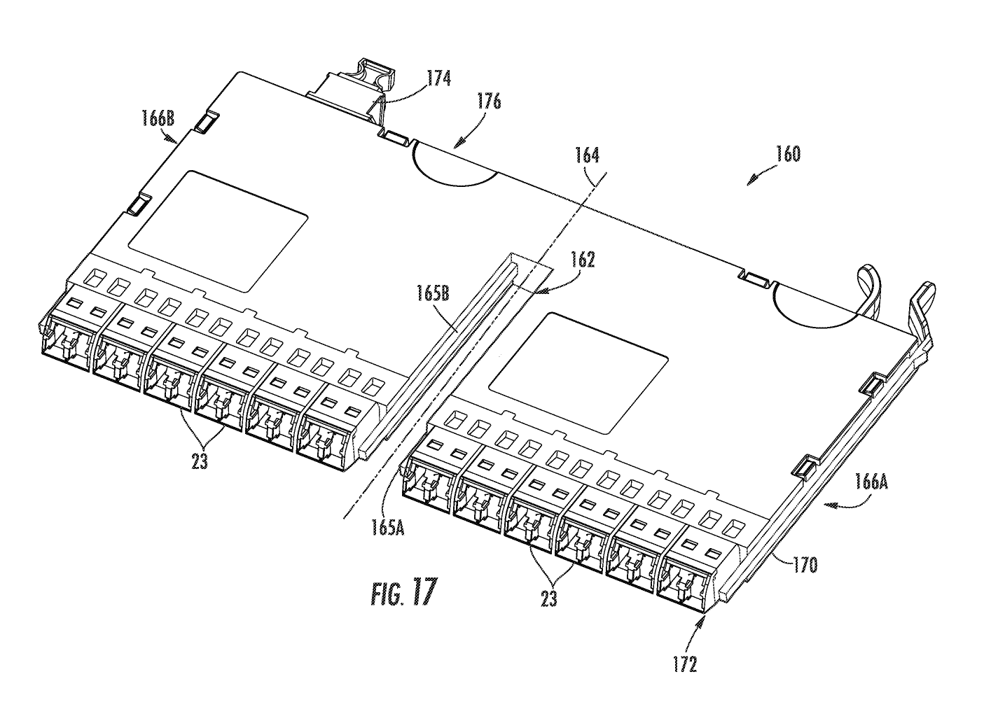

FIG. 16 illustrates an alternate fiber optic module 160 that may be provided in the fiber optic equipment trays 20 to support fiber optic connections and connection densities and bandwidths. FIG. 17 is a right front perspective view of the fiber optic module 160 of FIG. 16. In this embodiment, the fiber optic module 160 is designed to fit across two sets of module rail guides 32. A channel 162 is disposed through a center axis 164 of the fiber optic module 160 to receive a module rail guide 32 in the fiber optic equipment tray 20. Module rails 165A, 165B, similar to the module rails 28A, 28B of the fiber optic module 22 of FIGS. 1-13, are disposed on the inside the channel 162 of the fiber optic module 160 and configured to engage with tray channels 30 in the fiber optic equipment tray 20. Module rails 166A, 166B, similar to the module rails 28A, 28B of the fiber optic module 22 of FIGS. 1-13, are disposed on each side 168, 170 of the fiber optic module 160 that are configured to engage with tray channels 30 in the fiber optic equipment tray 20. The module rails 166A, 166B are configured to engage with tray channels 30 in a module rail guide 32 disposed between module rail guides 32 engaged with the module rail guides 32 disposed on the sides 168, 170 of the fiber optic module 160.

Up to twenty-four (24) fiber optic components 23 can be disposed in a front side 172 of the fiber optic module 160. In this embodiment, the fiber optic components 23 are comprised of up to twelve (12) duplex LC fiber optic adapters, which are connected to one twenty-four (24) fiber MPO fiber optic connector 174 disposed in a rear end 176 of the fiber optic module 160. Thus, with three (3) fiber optic equipment trays 20 disposed in the height of the chassis 12, a total of six (6) fiber optic modules 160 can be supported in a given 1-U space. Supporting up to twenty-four (24) fiber optic connections per fiber optic module 160 equates to the chassis 12 supporting up to one hundred forty-four (144) fiber optic connections, or seventy-two (72) duplex channels, in a 1-U space in the chassis 12 (i.e., twenty-four (24) fiber optic connections×six (6) fiber optic modules 160 in a 1-U space). Thus, the chassis 12 is capable of supporting up to one hundred forty-four (144) fiber optic connections in a 1-U space by twenty-four (24) simplex or twelve (12) duplex fiber optic adapters being disposed in the fiber optic modules 160. Supporting up to twenty (20) fiber optic connections per fiber optic module 160 equates to the chassis 12 supporting one hundred twenty (120) fiber optic connections, or sixty (60) duplex channels, in a 1-U space in the chassis 12 (i.e., twenty (20) fiber optic connections×six (6) fiber optic modules 160 in a 1-U space). Thus, the chassis 12 is also capable of supporting up to one hundred twenty (120) fiber optic connections in a 1-U space by twenty (20) simplex or ten (10) duplex fiber optic adapters being disposed in the fiber optic modules 160.

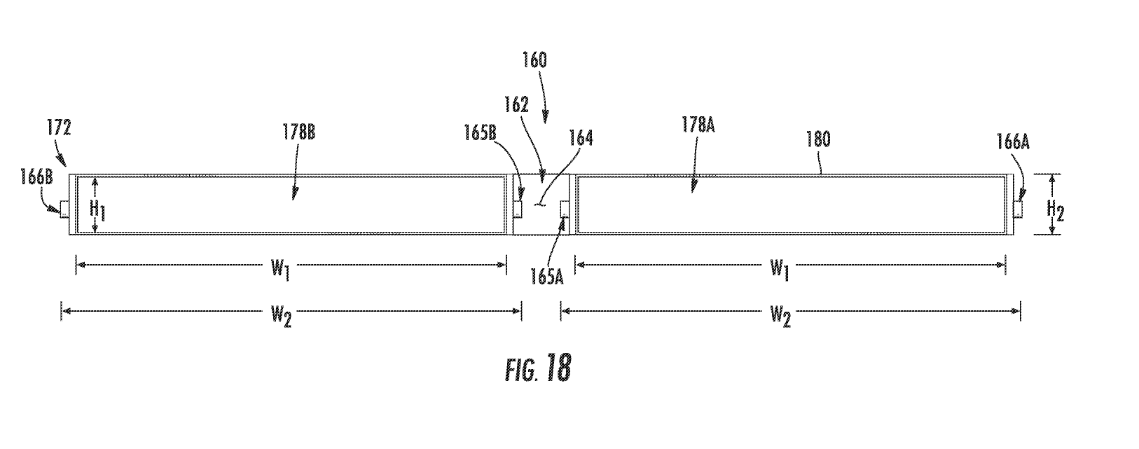

FIG. 18 illustrates a front view of the fiber optic module 160 of FIGS. 16-17 without loaded fiber optic components 23 in the front side 172 to further illustrate the form factor of the fiber optic module 160 in this embodiment. Front openings 178A, 178B disposed on each side of the channel 162 are disposed through the front side 172 of a main body 180 of the fiber optic module 160 to receive the fiber optic components 23. The widths W₁ and W₂ and the heights H₁ and H₂ are the same as in the fiber optic module 22 illustrated in FIG. 13. Thus, in this embodiment, the widths W₁ of front openings 178A, 178B are designed to be at least eighty-five percent (85%) of the width W₂ of the front side 172 of the main body 180 of the fiber optic module 160. The greater the percentage of the width W₁ to width W₂, the larger the area provided in the front openings 178A, 178B to receive fiber optic components 23 without increasing width W₂.

The width W₁ of the front openings 178A, 178B could each be designed to be greater than eighty-five percent (85%) of the width W₂ of the front side 172 of the main body 180 of the fiber optic module 160. For example, the width W₁ could be designed to be between ninety percent (90%) and ninety-nine percent (99%) of the width W₂. As an example, the width W₁ could be less than ninety (90) mm. As another example, the width W₁ could be less than eighty-five (85) mm or less than eighty (80) mm. For example, width W₁ may be eighty-three (83) mm and width W₂ may be eighty-five (85) mm, for a ratio of width W₁ to width W₂ of 97.6%. In this example, the front openings 178A, 178B may support twelve (12) fiber optic connections in the widths W₁ to support a fiber optic connection density of at least one fiber optic connection per 7.0 mm of width W₁ of the front openings 178A, 178B. Further, each of the front openings 178A, 178B may support twelve (12) fiber optic connections in the widths W₁ to support a fiber optic connection density of at least one fiber optic connection per 6.9 mm of width W₁ of the front openings 178A, 178B.

Further as illustrated in FIG. 18, the height H₁ of front openings 178A, 178B could be designed to be at least ninety percent (90%) of the height H₂ of the front side 172 of the main body 180 of the fiber optic module 160. In this manner, the front openings 178A, 178B have sufficient height to receive the fiber optic components 23, while three (3) fiber optic modules 160 can be disposed in the height of a 1-U space. As an example, the height H₁ could be twelve (12) mm or less or ten (10) mm or less. As an example, the height H₁ could be ten (10) mm and height H₂ could be eleven (11) mm, for a ratio of height H₁ to height H₂ of 90.9%.

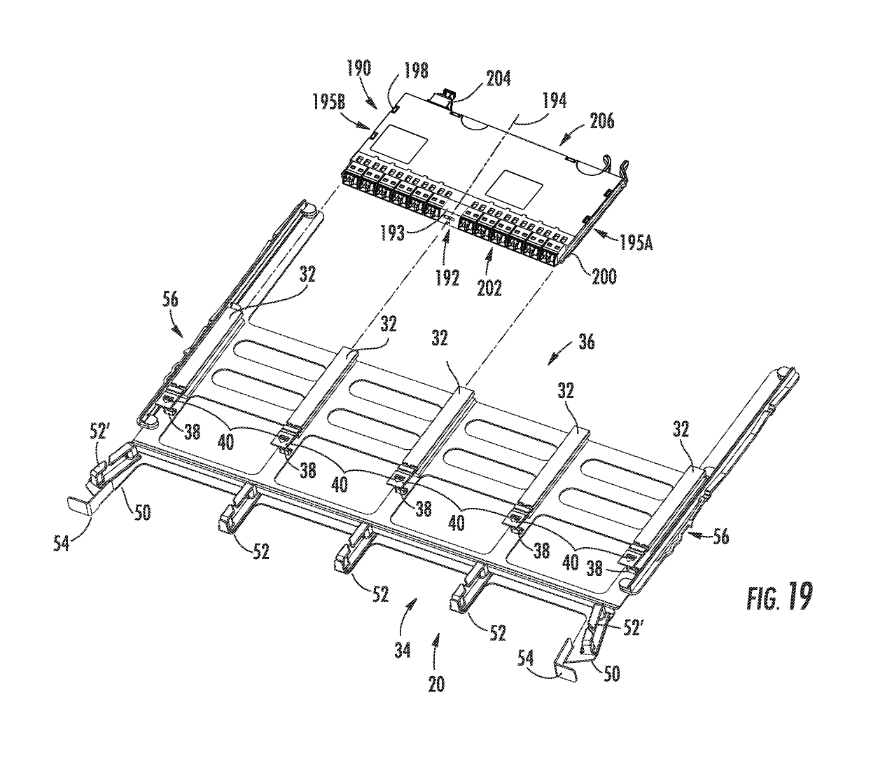

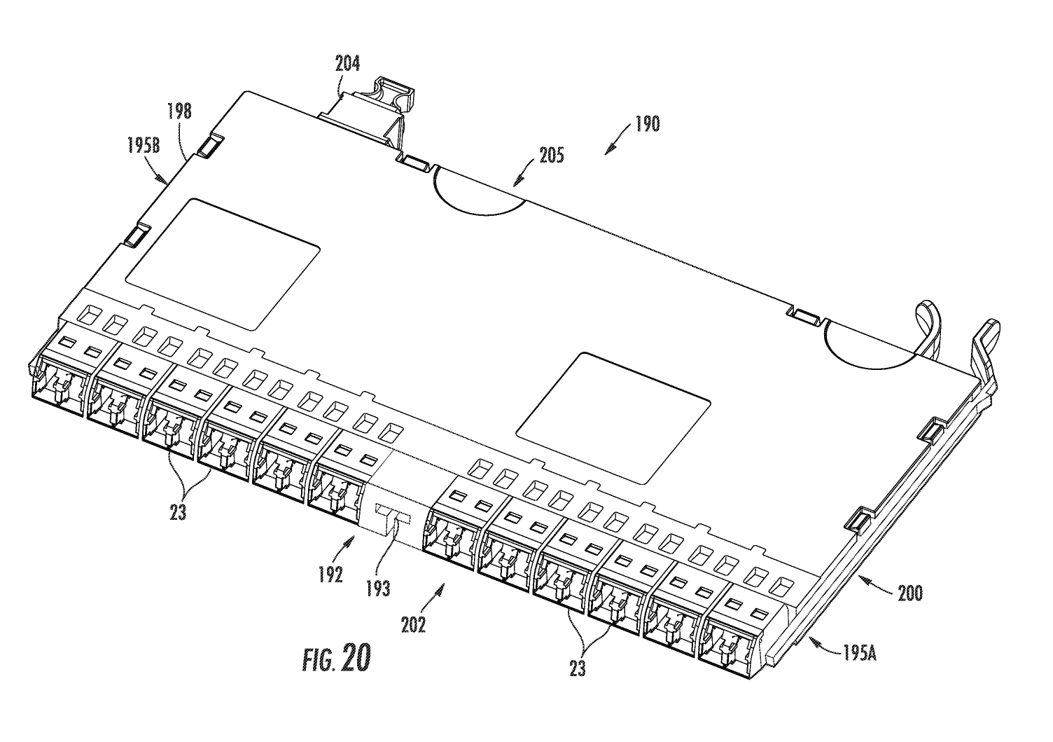

FIG. 19 illustrates another alternate fiber optic module 190 that may be provided in the fiber optic equipment trays 20 to support fiber optic connections and connection densities and bandwidths. FIG. 20 is a right front perspective view of the fiber optic module 190 of FIG. 19. In this embodiment, the fiber optic module 190 is designed to fit across two sets of module rail guides 32. A longitudinal receiver 192 is disposed through a center axis 194 and is configured to receive a module rail guide 32 in the fiber optic equipment tray 20 through an opening 193 in the receiver 192. Module rails 195A, 195B, similar to the module rails 28A, 28B of the fiber optic module 22 of FIGS. 1-13, are disposed on each side 198, 200 of the fiber optic module 190 that are configured to engage with tray channels 30 in the fiber optic equipment tray 20.

Up to twenty-four (24) fiber optic components 23 can be disposed in a front side 202 of the fiber optic module 190. In this embodiment, the fiber optic components 23 are comprised of up to twelve (12) duplex LC fiber optic adapters, which are connected to one twenty-four (24) fiber MPO fiber optic connector 204 disposed in a rear end 206 of the fiber optic module 190. Thus, with three (3) fiber optic equipment trays 20 disposed in the height of the chassis 12, a total of six (6) fiber optic modules 190 can be supported in a given 1-U space. Supporting up to twenty-four (24) fiber optic connections per fiber optic module 190 equates to the chassis 12 supporting up to one hundred forty-four (144) fiber optic connections, or seventy-two (72) duplex channels, in a 1-U space in the chassis 12 (i.e., twenty-four (24) fiber optic connections×six (6) fiber optic modules 190 in a 1-U space). Thus, the chassis 12 is capable of supporting up to one hundred forty-four (144) fiber optic connections in a 1-U space by twenty (24) simplex or twelve (12) duplex fiber optic adapters being disposed in the fiber optic modules 190. Supporting up to twenty-four (20) fiber optic connections per fiber optic module 190 equates to the chassis 12 supporting one hundred twenty (120) fiber optic connections, or sixty (60) duplex channels, in a 1-U space in the chassis 12 (i.e., twenty (20) fiber optic connections×six (6) fiber optic modules 190 in a 1-U space). Thus, the chassis 12 is also capable of supporting up to one hundred twenty (120) fiber optic connections in a 1-U space by twenty (20) simplex or ten (10) duplex fiber optic adapters being disposed in the fiber optic modules 190.

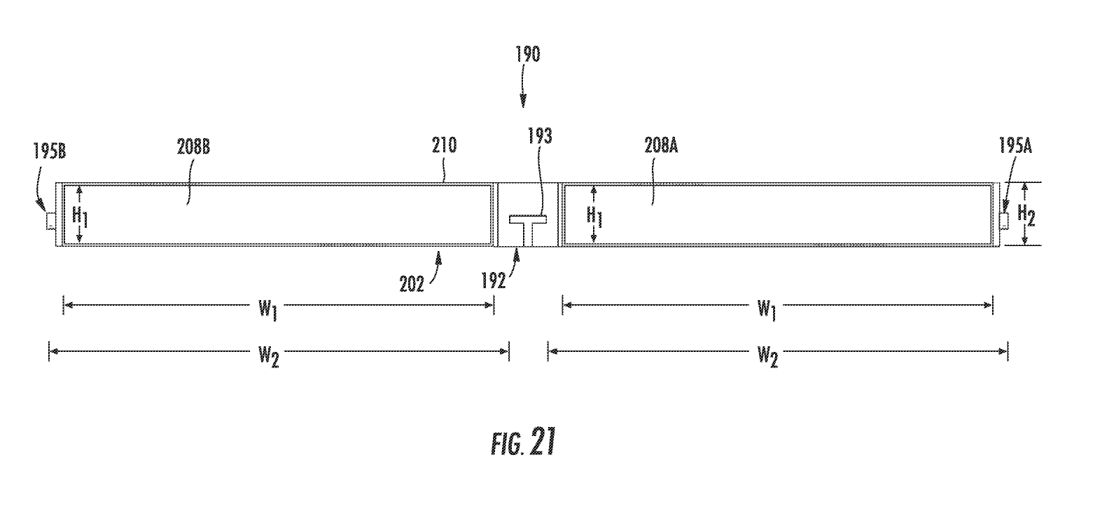

FIG. 21 illustrates a front view of the fiber optic module 190 of FIGS. 19-20 without loaded fiber optic components 23 in the front side 202 to further illustrate the form factor of the fiber optic module 190. Front openings 208A, 208B are disposed on each side of the receiver 192 and through the front side 202 of a main body 210 of the fiber optic module 190 to receive the fiber optic components 23. The widths W₁ and W₂ and the heights H₁ and H₂ are the same as in the fiber optic module 22 as illustrated in FIG. 13. Thus, in this embodiment, the width W₁ of front openings 208A, 208B is designed to be at least eighty-five percent (85%) of the width W₂ of the front side 202 of the main body 210 of the fiber optic module 190. The greater the percentage of the width W₁ to width W₂, the larger the area provided in the front openings 208A, 208B to receive fiber optic components 23 without increasing the width W₂.

The width W₁ of front openings 208A, 208B could each be designed to be greater than eighty-five percent (85%) of the width W₂ of the front side 202 of the main body 210 of the fiber optic module 190. For example, the width W₁ could be designed to be between ninety percent (90%) and ninety-nine percent (99%) of the width W₂. As an example, the width W₁ could be less than ninety (90) mm. As another example, the width W₁ could be less than eighty-five (85) mm or less than eighty (80) mm. For example, width W₁ may be eighty-three (83) mm and width W₂ may be eighty-five (85) mm, for a ratio of width W₁ to width W₂ of 97.6%. In this example, the front openings 208A, 208B may support twelve (12) fiber optic connections in the widths W₁ to support fiber optic connection density of at least one fiber optic connection per 7.0 mm of width W₁ of the front openings 208A, 208B. Further, each of the front openings 208A, 208B may support twelve (12) fiber optic connections in the widths W₁ to support a fiber optic connection density of at least one fiber optic connection per 6.9 mm of width W₁ of the front openings 208A, 208B.

Further as illustrated in FIG. 21, the height H₁ of front openings 208A, 208B could be designed to be at least ninety percent (90%) of the height H₂ of the front side 202 of the main body 210 of the fiber optic module 190. In this manner, the front openings 208A, 208B have sufficient height to receive the fiber optic components 23, while three (3) fiber optic modules 190 can be disposed in the height of a 1-U space. As an example, the height H₁ could be twelve (12) mm or less or ten (10) mm or less. As an example, the height H₁ could be ten (10) mm and the height H₂ could be eleven (11) mm, for a ratio of height H₁ to height H₂ of 90.9%.

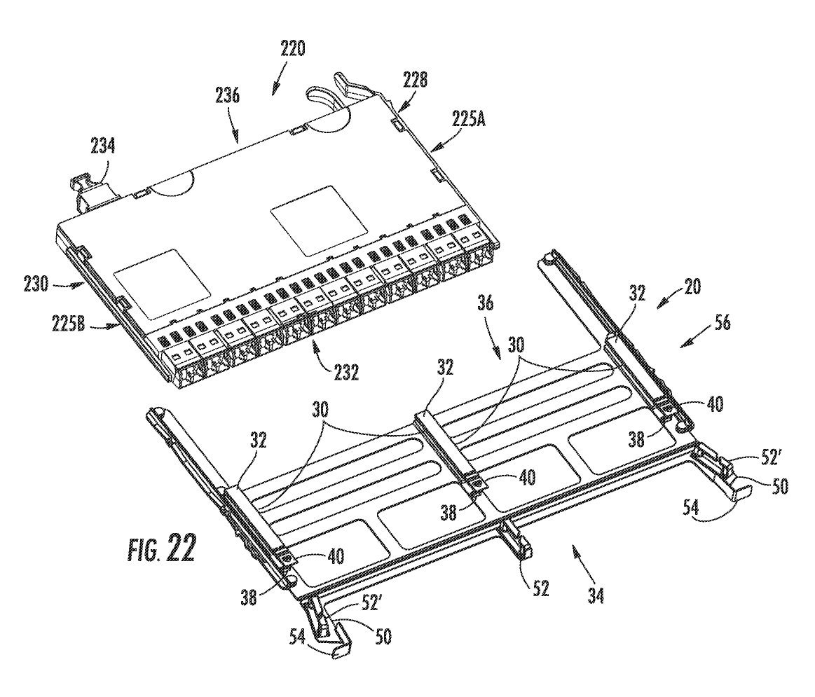

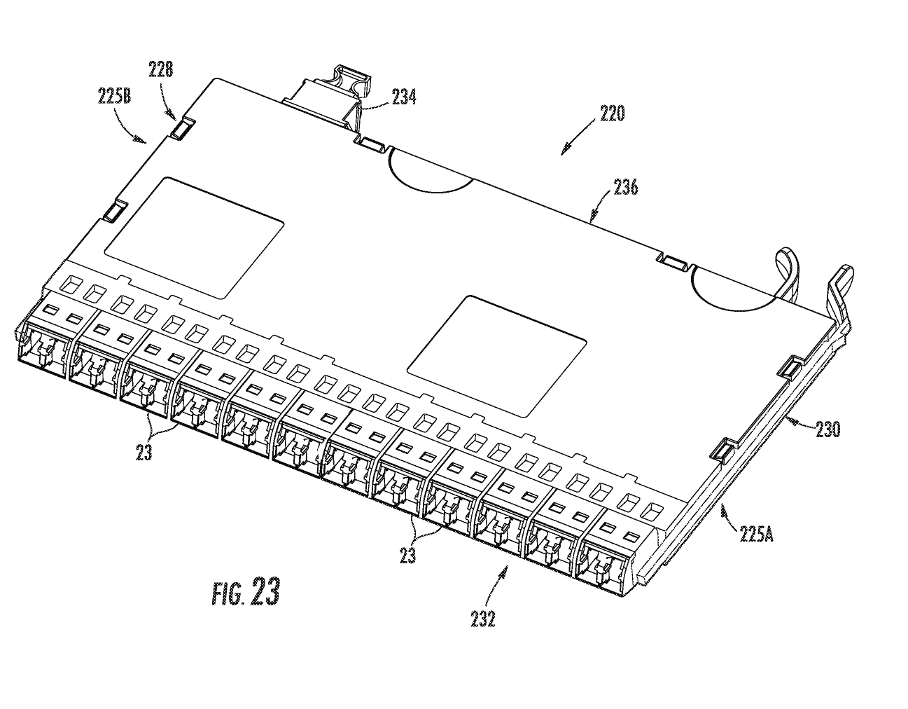

FIG. 22 illustrates another alternate fiber optic module 220 that may be provided in a fiber optic equipment tray 20′ to support a higher number of fiber optic connections and connection densities and bandwidths in a 1-U space. The fiber optic equipment tray 20′ in this embodiment is similar to the fiber optic equipment tray 20 previously discussed above; however, the fiber optic equipment tray 20′ only contains three (3) module rail guides 32 instead of five (5) module rail guides 32. Thus, the fiber optic equipment tray 20′ only supports two fiber optic modules 220 across a 1-U width space. Thus, the fiber optic module 220 does not have to provide the channel 162 or receiver 192 of the fiber optic modules 160, 190, respectively, to be disposed within the fiber optic equipment tray 20′. FIG. 23 is a right front perspective view of the fiber optic module 220 of FIG. 22. The fiber optic module 220 is designed to fit across one set of module rail guides 32 in the fiber optic equipment tray 20′. Module rails 225A, 225B, similar to the module rails 28A, 28B of the fiber optic module 22 of FIGS. 1-13, are disposed on each side 228, 230 of the fiber optic module 220 that are configured to engage with tray channels 30 in the fiber optic equipment tray 20′, as illustrated in FIG. 22.

Up to twenty-four (24) fiber optic components 23 can be disposed in a front side 232 of the fiber optic module 220. In this embodiment, the fiber optic components 23 are comprised of up to twelve (12) duplex LC fiber optic adapters, which are connected to one twenty-four (24) fiber MPO fiber optic connector 234 disposed in a rear end 236 of the fiber optic module 220. Thus, with three (3) fiber optic equipment trays 20′ disposed in the height of the chassis 12, a total of six (6) fiber optic modules 220 can be supported in a given 1-U space. Supporting up to twenty-four (24) fiber optic connections per fiber optic module 220 equates to the chassis 12 supporting up to one hundred forty-four (144) fiber optic connections, or seventy-two (72) duplex channels, in a 1-U space in the chassis 12 (i.e., twenty-four (24) fiber optic connections×six (6) fiber optic modules 220 in a 1-U space). Thus, the chassis 12 is capable of supporting up to one hundred forty-four (144) fiber optic connections in a 1-U space by twenty (24) simplex or twelve (12) duplex fiber optic adapters being disposed in the fiber optic modules 220. Supporting up to twenty (20) fiber optic connections per fiber optic module 220 equates to the chassis 12 supporting one hundred twenty (120) fiber optic connections, or sixty (60) duplex channels, in a 1-U space in the chassis 12 (i.e., twenty (20) fiber optic connections×six (6) fiber optic modules 220 in a 1-U space). Thus, the chassis 12 is also capable of supporting up to one hundred twenty (120) fiber optic connections in a 1-U space by twenty (20) simplex or ten (10) duplex fiber optic adapters being disposed in the fiber optic modules 220.

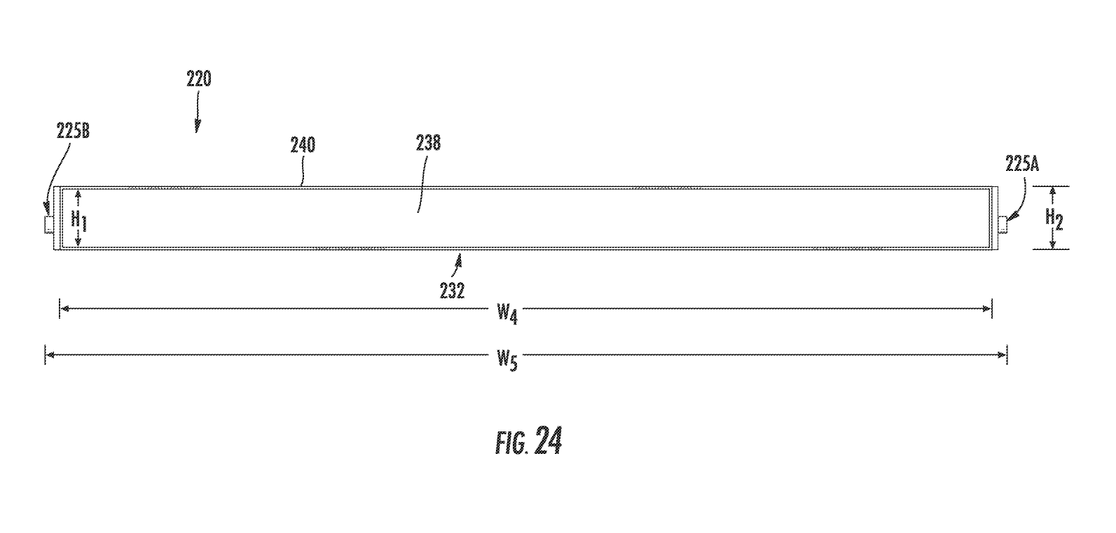

FIG. 24 illustrates a front view of the fiber optic module 220 of FIGS. 22-23 without loaded fiber optic components 23 in the front side 232 to further illustrate the form factor of the fiber optic module 220 in this embodiment. A front opening 238 is through the front side 232 of a main body 240 of the fiber optic module 220 to receive the fiber optic components 23. Width W₄ of the front opening 238 is twice the width W₁ of the front opening 98 in the fiber optic module 22 illustrated in FIG. 13. Width W₅ of the front side 232 is about one-hundred eighty-eight (188) millimeters, which is slightly greater than about twice the width W₃ of the fiber optic module 22 illustrated in FIG. 13. The heights H₁ and H₂ are the same as in the fiber optic module 22 illustrated in FIG. 13. Thus, in this embodiment, the width W₄ of the front opening 238 is designed to be at least eighty-five percent (85%) of the width W₅ of the front side 232 of the main body 240 of the fiber optic module 220. The greater the percentage of the width W₄ to the width W₅, the larger the area provided in the front opening 238 to receive fiber optic components 23 without increasing the width W₄.

Width W₄ of the front opening 238 could be designed to be greater than eighty-five percent (85%) of the width W₅ of the front side 232 of the main body 240 of the fiber optic module 220. For example, the width W₄ could be designed to be between ninety percent (90%) and ninety-nine percent (99%) of the width of W₅. As an example, the width W₄ could be less than one hundred eighty (180) mm. As another example, the width W₄ could be less than one hundred seventy (170) mm or less than one hundred sixty (160) mm. For example, width W₄ may be one hundred sixty-six (166) mm and width W₅ may be 171 mm, for a ratio of width W₄ to width W₅ of 166/171=97%. In this example, the front opening 238 may support twenty-four (24) fiber optic connections in the width W₄ to support a fiber optic connection density of at least one fiber optic connection per 7.0 mm of width W₄ of the front opening 238. Further, the front opening 238 may support twenty-four (24) fiber optic connections in the width W₄ to support a fiber optic connection density of at least one fiber optic connection per 6.9 mm of width W₄ of the front opening 238.

Further, as illustrated in FIG. 24, the height H₁ of the front opening 238 could be designed to be at least ninety percent (90%) of the height H₂ of the front side 232 of the main body 240 of the fiber optic module 220. In this manner, the front opening 238 has sufficient height to receive the fiber optic components 23, while three (3) fiber optic modules 220 can be disposed in the height of a 1-U space. As an example, the height H₁ could be twelve (12) mm or less or ten (10) mm or less. As an example, the height H₁ could be ten (10) mm and height H₂ could be eleven (11) mm, for a ratio of height H₁ to height H₂ of 90.9%.

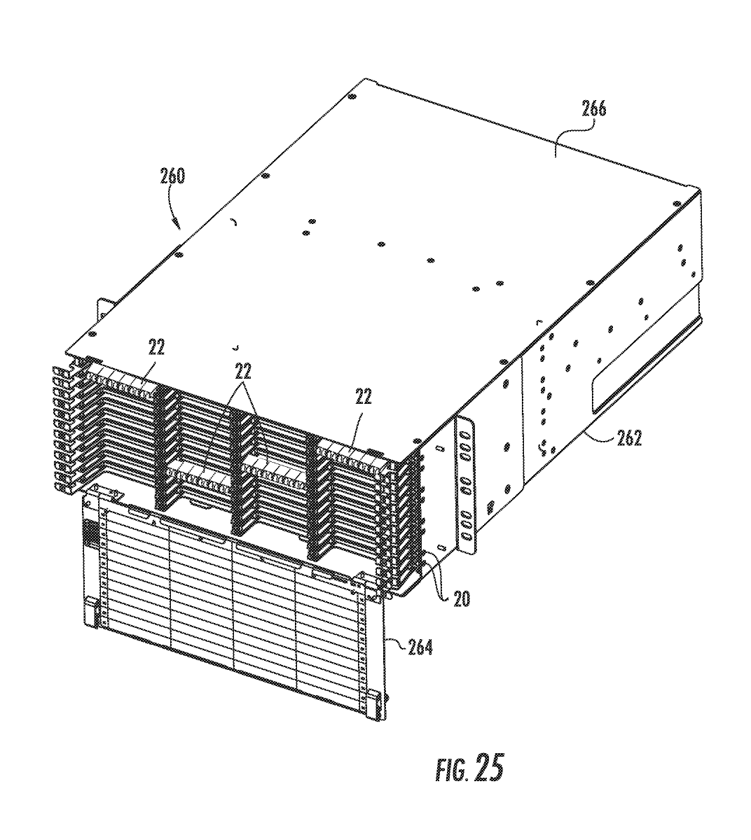

FIG. 25 illustrates another embodiment of fiber optic equipment 260 that can include fiber optic equipment trays previously described above and illustrated to support fiber optic modules. The fiber optic equipment 260 in this embodiment includes a 4-U sized chassis 262 configured to hold fiber optic equipment trays each supporting one or more fiber optic modules. The supported fiber optic equipment trays may be any of the fiber optic equipment trays 20, 20′ previously described above and thus will not be described again here. The supported fiber optic modules may be any of the fiber optic modules 22, 22′, 22″, 160, 190, 220 previously described above and thus will not be described again here. In this example, the chassis 262 is illustrated as supporting twelve (12) fiber optic equipment trays 20 each capable of supporting fiber optic modules 22.

The tray guides 58 previously described are used in the chassis 262 to support tray rails 56 of the fiber optic equipment trays 20 therein and to allow each fiber optic equipment tray 20 to be independently extended out from and retracted back into the chassis 262. A front door 264 is attached to the chassis 262 and is configured to close about the chassis 262 to secure the fiber optic equipment trays 20 contained in the chassis 262. A cover 266 is also attached to the chassis 262 to secure the fiber optic equipment trays 20. However, in the chassis 262, up to twelve (12) fiber optic equipment trays 20 can be provided. However, the fiber optic connection densities and connection bandwidths are still the same per 1-U space. The fiber optic connection densities and connection bandwidth capabilities have been previously described and equally applicable for the chassis 262 of FIG. 25, and thus will not be described again here.

Thus, in summary, the table below summarizes some of the fiber optic connection densities and bandwidths that are possible to be provided in a 1-U and 4-U space employing the various embodiments of fiber optic modules, fiber optic equipment trays, and chassis described above. For example, two (2) optical fibers duplexed for one (1) transmission/reception pair can allow for a data rate often (10) Gigabits per second in half-duplex mode or twenty (20) Gigabits per second in full-duplex mode. As another example, eight (8) optical fibers in a twelve (12) fiber MPO fiber optic connector duplexed for four (4) transmission/reception pairs can allow for a data rate of forty (40) Gigabits per second in half-duplex mode or eighty (80) Gigabits per second in full-duplex mode. As another example, twenty optical fibers in a twenty-four (24) fiber MPO fiber optic connector duplexed for ten (10) transmission/reception pairs can allow for a data rate of one hundred (100) Gigabits per second in half-duplex mode or two hundred (200) Gigabits per second in full-duplex mode. Note that this table is exemplary and the embodiments disclosed herein are not limited to the fiber optic connection densities and bandwidths provided below.

| | Max | Max | Number of | Number of | Bandwidth per 1 U | Bandwidth per 1 U | Bandwidth per 1 U |
|---|---|---|---|---|---|---|---|
| | Fibers | Fibers | Connectors | Connectors | using 10 Gigabit | using 40 Gigabit | using 100 Gigabit |
| Connector | per | per | per 1 RU | per 4 RU | Transceivers | Transceivers | Transceivers |
| Type | 1 RU | 4 RU | Space | Space | (duplex) | (duplex) | (duplex) |
| Duplexed LC | 144 | 576 | 72 | 288 | 1,440 Gigabits/s. | 960 Gigabits/s. | 1,200 Gigabits/s. |
| 12-F MPO | 576 | 2,304 | 48 | 192 | 5,760 Gigabits/s. | 3,840 Gigabits/s. | 4,800 Gigabits/s. |
| 24-F MPO | 1,152 | 4,608 | 48 | 192 | 11,520 Gigabits/s. | 7,680 Gigabits/s. | 9,600 Gigabits/s. |

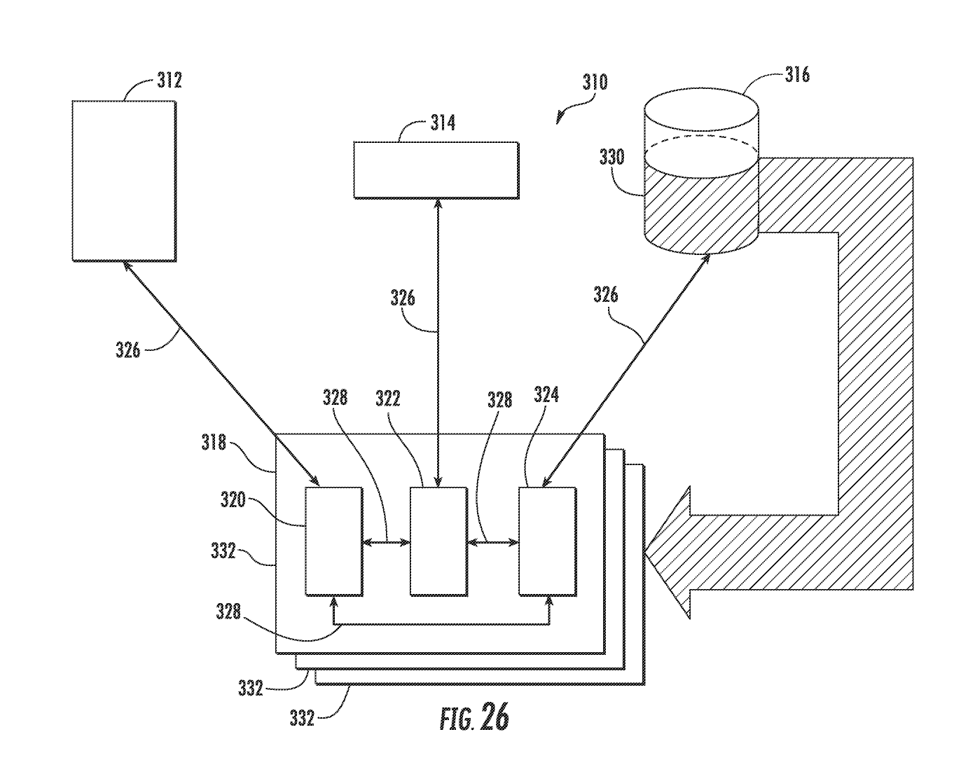

The fiber optic equipment discussed above may be located in data centers. The data centers may be arranged in architectures that facilitate the receipt, storing, retrieval and transmitting of data. One such architecture may include a type of data storage facility, for example, a storage area network. FIG. 26 illustrates an embodiment of one type of data center architecture 310. The data center architecture 310 comprises a server 312, a switch 314 and a data storage facility 316. Although each of the server 312, the switch 314 and the data storage facility 316 are shown as one functional block, it should be understood that they may include any number of such components, associated hardware and software, which, as examples, may include, without limitation, proxy servers, load balancers, routers and the like. The server 312, the switch 314 and the data storage facility 316 interconnect with each other through a fiber optic connection infrastructure 318. In FIG. 26, communication from the server 312, the switch 314 and the data storage facility 316 to the fiber optic connection infrastructure 318 is bi-directional. Thus, data is transmitted and received by and between the server 312, the switch 314 and the data storage 316 through the fiber optic connection infrastructure 318.

The fiber optic connection infrastructure 318 may include dedicated ports to establish optical connectivity with each of the server 312, the switch 314 and the data storage facility 316. As such, the server 312 will optically connect with the fiber optic connection infrastructure 318 through one or more server ports 320. The switch 312 will optically connect with the fiber optic connection infrastructure 318 through one or more switch ports 322. And, the data storage facility 316 will optically connect with the fiber optic connection infrastructure 318 through one or more storage ports 324. In this manner, bi-directional communication channels 326 may be established between the server 312 and the fiber optic connection infrastructure 318 through the server ports 320, between the switch 314 and the fiber optic connection infrastructure 318 through the switch ports 322, and between the data storage facility 316 and the fiber optic connection infrastructure 318 through storage ports 324. Additionally, bi-directional communication channels 328 may be established in the fiber optic connection infrastructure 318 between the server ports 320, the switch ports 322, and the storage ports 324. The bi-directional communication channel 326 may be based on one or more fiber optic cables in the form of one or more trunk cables. The bi-directional communication channel 328 may be based on one or more fiber optic cables in the form of one or more jumper cables.

The fiber optic connection infrastructure 318 may be configured to support the transmission and receipt of data in the data center based on the data capacity 330 of the data center. This is represented in FIG. 26 by the cross-hatched portion of the data storage facility 316. The data capacity 330 may be expressed in terabytes of data. Thus, the fiber optic connection infrastructure 318 is configured to handle at least the amount of terabytes of data of the data center data capacity 330. As will be discussed in detail later, the fiber optic connection infrastructure 318 comprises one or more fiber optic equipment racks 332. The fiber optic equipment rack 332 is configured to hold fiber optic equipment which comprises the server ports 320, the switch ports 322, and the storage ports 324. The amount of data a fiber optic equipment rack 332 can handle may be based on the number of optical fibers that can be connected to the server ports 320, the switch ports 322, and the storage ports 324 on a fiber optic equipment rack 332. Additionally, each fiber optic equipment rack 332 occupies a certain amount of floor space in the data center. Therefore, the more data capacity 330 that a fiber optic equipment rack 332 can handle, the less fiber optic equipment racks 332 required for a data center and the less floor space of the data center used.

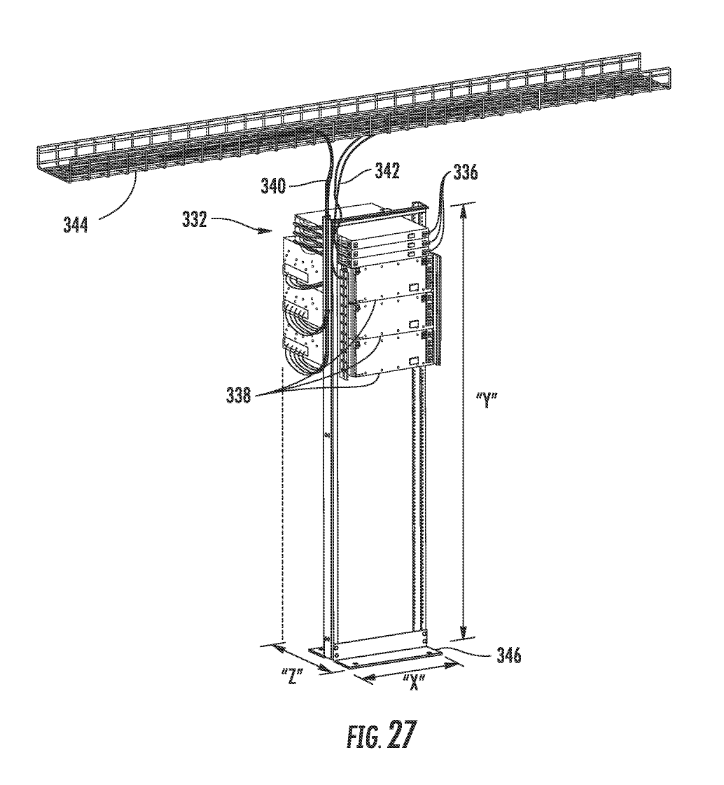

FIG. 27 illustrates an exemplary embodiment of a fiber optic equipment rack 332. The fiber optic equipment rack 332 may comprise a number of “U” space fiber optic equipment units. A 1-U space fiber optic equipment unit 334 has the dimension of, about, 19 inches wide and 1.75 inches high. Another 1U space may be 23 inches wide and 1.75 inches high. In FIG. 27, the fiber optic equipment rack 332 comprises 42 U space fiber optic equipment units 334 stacked in a vertical arrangement, or, in other words, in the “Y” dimension. Fiber optic equipment may be located on and/or held by the fiber optic equipment rack 332 in one or more “U” space fiber optic equipment units. In the embodiment in FIG. 27, three 1U space sized fiber optic equipment chassis 336 and three 4U space sized fiber optic equipment chassis 334 are shown in the fiber optic equipment rack 332. Trunk fiber optic cables 340 and jumper fiber optic cables 342 are shown routed from the 1U space sized fiber optic equipment chassis 336 and the 4U space sized fiber optic equipment chassis 334 up the side of the fiber optic equipment rack 332 to an overhead cable tray 344. The trunk fiber optic cables 340 and jumper fiber optic cables 342 would route to other components and equipment as appropriate.

As discussed above, the amount of data a fiber optic equipment rack 332 can handle may be based on the number of optical fibers that can be connected to the server ports 320, the switch ports 322, and the storage ports 324 on a fiber optic equipment rack 332. In the embodiment shown in FIG. 27, the fiber optic equipment rack 332 is configured to connect at least up to about 5760 optical fibers. The fiber optic equipment rack 332 is configured to support the transmission of data based on a data center architecture having a system with a capacity to manage at least 7300 terabytes of data. Additionally, the fiber optic equipment rack 332 is configured to support the transmission of data based on a data center architecture having a system with a capacity to manage at least from 7300 terabytes of data to at least 14,400 terabytes of data. Further, the fiber optic equipment rack 332 is configured to support the transmission of data based on a data center architecture having a system with a capacity to manage at least 14,400 terabytes of data.

In the embodiment shown in FIG. 27, the fiber optic equipment rack 332 is floor mounted. As such, fiber optic equipment rack 332 will occupy a certain amount of floor space. Although the actual base 346 of the fiber optic equipment rack 332 may be a certain, the floor space actually occupied may be larger based on any portion of the fiber optic equipment that may extend past the base 346. In other words, the footprint for the fiber optic equipment rack 332 may be larger than the base 346. In FIG. 27, the footprint of the fiber optic equipment rack 332 may be determined from the “X” and “Z” dimensions. In the embodiment shown in FIG. 27, the “X” dimension is the width of the fiber optic equipment rack 332 and may be about 20.18 inches. The “Z” dimension is the depth of the fiber optic equipment rack 332 and may be about 22.86 inches. The amount of floor space for the footprint may be calculated as:

20.18 in.×22.86 in.=461.31 in.² -or- 461.31/144=3.20 ft.²

Additionally, the “Z” dimension may increase to about 26.86 for example due to the depth of a 4U space sized fiber optic equipment chassis 334. In such a case, the calculation of the floor space would be:

20.18 in.×26.86 in.=542.03 in.² -or- 542.03/144=3.76 ft.²

Accordingly, each fiber optic equipment rack 332 may occupy approximately about 3.20 ft.² 3.76 ft.² of floor space in the data center. Other footprint sizes are possible based on the type of fiber optic equipment rack 332.

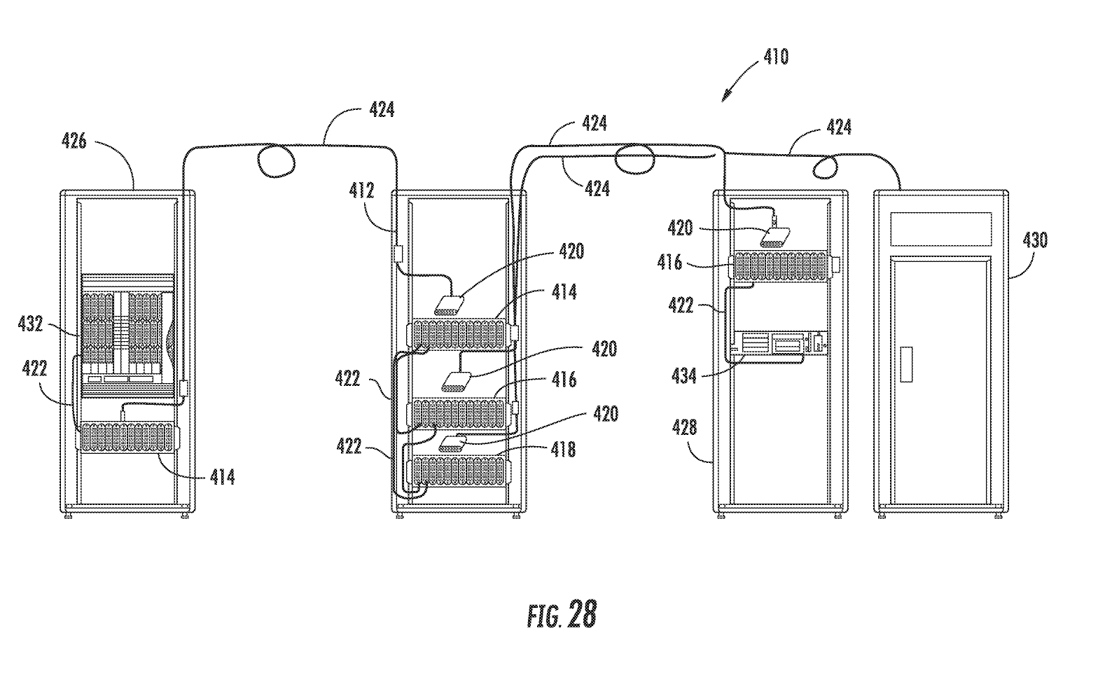

Referring now to FIG. 28, there is shown an exemplary embodiment of an arrangement of the components and the fiber optic connection infrastructure 318 in a data center 410. The data center 410 includes one main distribution area (MDA) fiber optic equipment rack 412. In FIG. 28, the MDA fiber optic equipment rack 412 is shown with three 4U space sized fiber optic equipment chassis for use as switch ports 414, server ports 416, and the storage ports 418. The switch ports 414, server ports 416, and the storage ports 418 may positioned in modules 420. Jumper fiber optic cables 422 route between the switch ports 414, server ports 416, and the storage ports 418. Trunk fiber optic cables 424 would route between the MDA fiber optic equipment rack 412 and switch fiber optic equipment rack 426, a server fiber optic equipment rack 428 and a data storage facility 430. The switch fiber optic equipment rack 426, a server fiber optic equipment rack 428 and a data storage facility 430 may be located in the equipment distribution area (EDA) of the data center 410.

The switch fiber optic equipment rack 426 holds the switch 432 and switch ports 414. The trunk fiber optic cable 424 routed to the switch fiber optic equipment rack 426 optically connects to switch ports 414 located in the switch fiber optic equipment rack 426. Jumper fiber optic cable 422 optically connects the switch 432 to the switch ports 414 located in the switch fiber optic equipment rack 426, and, thereby, to the trunk fiber optic cable 424 and the switch ports 414 located in the switch fiber optic equipment rack 426. The server fiber optic equipment rack 428 holds the server 434 and server ports 416. The trunk fiber optic cable 424 routed to the server fiber optic equipment rack 428 optically connects to server ports 416 located in the server fiber optic equipment rack 428. Jumper fiber optic cable 422 optically connects the server 434 to the server ports 416 located in the server fiber optic equipment rack 428, and, thereby, to the trunk fiber optic cable 424 and the server ports 416 located in the switch fiber optic equipment rack 426. The trunk fiber optic cable 424 routed to the data storage facility 430 optically connects the data storage facility 430 to the storage ports 418 located in the switch fiber optic equipment rack 426.

As used herein, the terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. Likewise, other types of suitable optical fibers include bend-insensitive optical fibers, or any other expedient of a medium for transmitting light signals. An example of a bend-insensitive optical fiber is ClearCurve® Multimode fiber commercially available from Corning Incorporated.

Other arrangements, configurations and architectures of the data center 310 and the fiber optic connection infrastructure are possible. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A fiber optic apparatus, comprising:
fiber optic equipment configured to provide optical connectivity for the transmission of data over optical fiber,
wherein the fiber optic equipment supports the transmission of at least 7300 terabytes of data per forty-two (42) U shelf spaces.

2. The fiber optic apparatus of claim 1, wherein a U shelf space equals about 1.75 inches in height.

3. The fiber optic apparatus of claim 1, wherein a U shelf space equals about 19 inches in width.

4. The fiber optic apparatus of claim 1, wherein a U shelf space equals about 23 inches in width.

5. The fiber optic apparatus of claim 1, wherein the fiber optic equipment mounts in at least a portion of the 1-U shelf space in an equipment rack.

6. The fiber optic apparatus of claim 5, wherein the equipment rack is located in a main distribution area of a data center.

7. The fiber optic apparatus of claim 5, wherein the equipment rack is configured to occupy between about 3.20 and about 3.76 square feet of floor space.

8. The fiber optic apparatus of claim 1, wherein the transmission of data is between at least two components, and wherein the at least 7300 terabytes of data is the data managing capacity of the at least two components.

9. The fiber optic apparatus of claim 8, wherein one of the at least two components comprises a data storage facility.

10. The fiber optic apparatus of claim 9, wherein the data storage facility is located in the equipment distribution area of a data center.

11. The fiber optic apparatus of claim 8, wherein one of the at least two components comprises a server.

12. The fiber optic apparatus of claim 11, wherein the server is located in the equipment distribution area of a data center.

13. The fiber optic apparatus of claim 8, wherein one of the at least two components comprises a switch.

14. The fiber optic apparatus of claim 13, wherein the switch is located in the equipment distribution area of a data center.

15. A fiber optic apparatus, comprising:
fiber optic equipment configured to provide optical connectivity for the transmission of data over optical fiber,
wherein the fiber optic equipment supports the transmission of at least 14,400 terabytes of data per forty-two (42) U shelf spaces.

16. The fiber optic apparatus of claim 15, wherein a U shelf space equals about 1.75 inches in height.

17. The fiber optic apparatus of claim 15, wherein a U shelf space equals about 19 inches in width.

18. The fiber optic apparatus of claim 15, wherein a U shelf space equals about 23 inches in width.

19. The fiber optic apparatus of claim 15, wherein the fiber optic equipment mounts in at least a portion of the U shelf space in an equipment rack.

20. The fiber optic apparatus of claim 19, wherein the equipment rack is located in a main distribution area of a data center.

21. The fiber optic apparatus of claim 19, wherein the equipment rack is configured to occupy between about 3.20 and about 3.76 square feet of floor space.

22. The fiber optic apparatus of claim 15, wherein the transmission of data is between at least two components, and wherein the at least 14,400 terabytes of data is the data managing capacity of the at least two components.

23. The fiber optic apparatus of claim 22, wherein one of the at least two components comprises a data storage facility.

24. The fiber optic apparatus of claim 23, wherein the data storage facility is located in the equipment distribution area of a data center.

25. The fiber optic apparatus of claim 22, wherein one of the at least two components comprises a server.

26. The fiber optic apparatus of claim 25, wherein the server is located in the equipment distribution area of a data center.

27. The fiber optic apparatus of claim 22, wherein one of the at least two components comprises a switch.

28. The fiber optic apparatus of claim 27, wherein the switch is located in the equipment distribution area of a data center.

29. A fiber optic apparatus, comprising:
a fiber optic equipment rack configured to hold fiber optic equipment providing optical connectivity for the transmission of data over optical fiber between at least two or more of the components, and
wherein the fiber optic equipment rack is configured to support the transmission of data based on a data capacity of a data center, wherein the data capacity is one of at least 7300 terabytes of data, and at least 14,400 terabytes of data, per forty-two (42) U shelf spaces.

30. The fiber optic apparatus of claim 29, wherein the fiber optic equipment rack is configured to occupy between about 3.20 and about 3.76 square feet of floor space.

31. The fiber optic apparatus of claim 30, wherein the fiber optic equipment rack is comprises at least forty-two (42) U shelf spaces.

32. The fiber optic apparatus of claim 30, wherein the equipment rack is located in a main distribution area of a data center.

33. The fiber optic apparatus of claim 30, wherein one of the at least two components comprises a data storage facility.

34. The fiber optic apparatus of claim 33, wherein the data storage facility is located in an equipment distribution area of a data center.

35. The fiber optic apparatus of claim 30, wherein one of the at least two components comprises a server.

36. The fiber optic apparatus of claim 35, wherein the server is located in the equipment distribution area of a data center.

37. The fiber optic apparatus of claim 30, wherein one of the at least two components comprises a switch.

38. The fiber optic apparatus of claim 37, wherein the switch is located in the equipment distribution area of a data center.

39. A data center architecture, comprising
a data storage facility having a data storing capacity;
an equipment distribution area comprising one or both of a server and a switch, wherein the one or both of the server and the switch process data of the data storage facility; and
a main distribution area comprising fiber optic equipment configured to support the transmission of data between at least two of the data storage facility, the server, and the switch, based on the data storing capacity of the data storage facility.

40. The data center architecture of claim 39, wherein the data storing capacity is storage 7300 terabytes of data.

41. The data center architecture of claim 39, wherein the data storing capacity is storage 14,400 terabytes.

42. The data center architecture of claim 39, wherein the fiber optic equipment is mounted in fiber optic equipment rack, and wherein the fiber optic equipment rack occupies between about 3.20 and about 3.76 square feet of floor space of the data center.

43. The data center architecture of claim 42, wherein the fiber optic equipment rack comprises at least forty-two (42) U shelf spaces.

44. The data center architecture of claim 42, further comprising a bi-directional communication channel, wherein the bi-directional communication channel extends between the fiber optic equipment and one or more of the data storage facility, the server and the switch.

45. The data center architecture of claim 39, wherein the fiber optic equipment comprises one or more of a storage port, a server port, and a switch port, forming a fiber optic connection infrastructure.
